(19) United States
(12) Patent Application Publication
(10) Pub. No.: US 2005/0168707 A1
(43) Pub. Date: Aug. 4, 2005

(54) Convertible projection assembly and method

(76) Inventors: Thomas G. Feldpausch, Hastings, MI (US); Kirt D. Martin, Alto, MI (US); Joel T. Ruiter, Grand Rapids, MI (US)

Correspondence Address: QUARLES & BRADY LLP, 411 E. WISCONSIN AVENUE, SUITE 2040, MILWAUKEE, WI, 53202-4497, US

(21) Appl. No.: 10/769,685

(22) Filed: Jan. 30, 2004

(51) Int. Cl. G09G 3/28

(52) U.S. Cl. 353/79; 345/60

(57) ABSTRACT

A convertible projection assembly and method, the assembly including a support structure, a translucent screen member including a viewing front surface and an oppositely facing rear surface, the screen member releasably mountable to the support structure and a reflecting member forming an internal surface and an oppositely facing external surface, the internal surface of the reflecting member at least in part forming a reflecting surface, the reflecting member releasably mounted to the support structure such that the reflecting surface at least in part faces the rear surface of the screen member.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates generally to rear projection units and more specifically to a convertible assembly that projects an image through a projecting space and onto a screen when the assembly is configured to provide a projecting function and that may use the projecting space for a different function when the assembly is configured to provide a non-projecting function.

This section of this document is intended to introduce various aspects of art that may be related to various aspects of the present invention described and/or claimed below. This section provides background information to facilitate a better understanding of the various aspects of the present invention. It should be understood that the statements in this section of this document are to be read in this light, and not as admissions of prior art.

Modern office facilities typically include several types of systems that help facilitate sharing of ideas between employees. One particularly useful type of system for sharing ideas has been erasable/writable whiteboards where special ink pens can be used to manually provide information on the boards during a sharing session and, thereafter, the information can be erased and the board surface reused.

Another useful type of system for sharing information has been projection systems that enable video presentation of information on relatively large display screens. These types of projection systems have generally taken two different forms including front and rear projection systems. Front projection systems, as the label implies, include a projector that projects images on the front surface of a display screen from the viewing side of the display screen. Here, the projector may be supported on a table or mounted to a ceiling while the display screen may be mounted to a wall or to a ceiling.

While front projectors are typically easily portable and therefore can be used in many different locations, unfortunately, these system have several shortcomings. First, the screens used with front projectors typically are relatively large and are not easily portable. For this reason, where a projector is to be used in many different location, a separate screen usually has to be available at each of the locations.

Second, often, the best place for a person presenting information to be located is directly next to the information so that the presenter can physically point out various parts of the information on the large projected image. In the case of a front projector, unfortunately, a presenter's presence between the projector and the image results in a shadow being cast on the display screen and temporary loss of at least some of the presented information.

Third, where a projector is portable, when a projector is brought into a room for use, prior to using the projector several power, data and control linkages are typically required. While projector manufacturers have taken steps to streamline the projector linkage tasks, these tasks are often time consuming and are generally viewed as tedious and as an impediment to use.

Fourth, where a front projector is used, often, there is a minimum projector-to-screen distance requirement that cannot be met in small spaces such as modest offices or cubicles. For this reason, in many cases, a limited number of conference rooms in a facility may be the only suitable locations in which to use front projector systems even when the number of people that attend a presentation is small.

Rear projection systems, as the label implies, include a projector that projects images on a rear surface of a translucent screen where screen viewers view the images on a front surface that faces in a direction opposite the rear surface. In most cases rear projection systems comprise wholly integrated systems wherein the projector is mounted within a housing and the display screen is mounted in one side of the housing for presenting the images. Here, one or more reflecting mirrors or the like are often provided in the housing between the projector and the screen so that the image size can be increased while still maintaining a relatively narrow assembly depth (i.e., dimension from the screen to the back of the housing).

Some rear projection units have been equipped with an erasable marker type display screen surface (e.g., a translucent marker board type surface) so that information can be added to projected images by a system user. In some cases, when information is added to a display screen via a pen or the like, the system is equipped to recognize the information and to record the information for addition to the images. One such system for identifying data added to a whiteboard display surface is described in U.S. patent application Ser. No. 10/452,178 which is entitled “Electronic Whiteboard”, the content of which is incorporated herein in its entirety be reference.

Rear projection systems like the ones described above solve many of the problems associated with front projection systems. For instance, rear projection systems typically require less space than front projection systems and therefore are useable in many different facility locations. In addition, rear projection systems are fully integrated so typically at least some of the data, power and control linkages need only be made once by a manufacturer or a trained technician. Moreover, with a rear projection system, a user can stand directly in front of an image between the screen and an audience without casting a shadow on the resulting image. Furthermore, with a rear projection system that includes a whiteboard type surface, information can easily be added to displayed images during viewing.

Unfortunately, while rear projection systems provide many advantages, rear projection systems also have several shortcomings. First, because rear projection systems require a dedicated housing structure for defining the projection path of images from a projector, rear projection systems are typically relatively bulky. Because of their size, a relatively large space is typically required to store a rear projection system.

Second, because of their large size, while most rear projection systems may fit within relatively small rooms, such systems are rarely used in small rooms. For instance, while a rear projector may fit within a standard sized cubicle, such systems would leave little room for a presenter and an audience within the cubicle and therefore are only rarely used within such a small space. This is especially true in cases where cubicles already include other office furniture including a desk, book shelves, one or more chairs and/or one or more working surfaces.

Third, in addition to being of a large size, many rear projectors are also relatively heavy so that, despite being transportable, most rear projectors are only rarely moved from one location to another for remote use. In fact, because of their bulkiness, despite requiring less space than typical front projection systems, in many cases rear projection systems are rarely moved within even a single facility.

Fourth, because rear projection systems require a support structure, a housing assembly and often one or more reflecting mirror assemblies, the overall costs of these systems is relative high.

Fifth, because rear projection systems are typically integrated into a complete housing, many people do not understand how rear projection systems operate. While lack of operational knowledge may not appear to be an important concern at first blush, it is believed that, as with many emerging technologies, lack of operational knowledge has, in the past, lead to underutilization of rear projection systems.

Sixth, while some rear projection systems include a screen surface suitable for use as a whiteboard, in most cases projection screens are not employed for this purpose when conventional whiteboard functionality without projection is required. Instead, where both rear projection capabilities and conventional whiteboard capabilities are routinely separately required within a facility, typically separate dedicated projection systems and whiteboard systems are provided.

Seventh, to increase stability (i.e., minimize the possibility of tipping), rear projection systems typically have a relatively low profile. This is particularly true of system that are relatively heavy. While low profiles increase stability, such profiles typically reduce the height of the projection screen and thus reduce the usefulness of a system for presenting information to large audiences. A related limitation is that the height of a rear projection screen typically is not adjustable.

Thus, it would be advantageous to have an inexpensive, easily portable, easily height adjustable, easily storable information sharing assembly that is intuitive to use for displaying images as well as for presenting manually applied information.

### BRIEF SUMMARY OF THE INVENTION

Certain aspects commensurate in scope with the invention originally claimed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

It has been recognized that various common office facility structures can be easily converted from their normal configurations into part of a rear projection system thereby providing a dual function and hence reducing system costs appreciably. More specifically, various common office facility structures can be used to support a display screen, a reflecting member and a projector in functionally operable juxtapositions.

It has also been recognized that the display screen, reflecting member and projector may be designed to have forms that are relatively easy to handle, are easily portable and that require minimal storage space.

Based on these recognitions, at least certain embodiments of the present invention include a common facility structure that has a first purpose and that can be converted for use with other components to provide a rear projection system. For instance, in at least some embodiments, when shelf members are removed from vertical shelf support members, the uprights are useable to mount a display screen and a reflecting member and to support a projector so as to form a rear projection configuration wherein images are projected through the space from which the shelf members were removed. Thus, in these cases, the vertical shelf supports are useable in either a rear projection configuration or in a shelving configuration.

In the above shelf-projection example, the screen and reflecting member may be relatively light weight and therefore easy to manipulate and transport. In at least some embodiments it is contemplated that the screen and reflecting member may be couplable to the vertical supports at different heights to adjust the height of the projected image to suit specific optimal user requirements.

In many cases it is contemplated that coupling hardware or features used to support the shelves may also be useable to support the screen and reflecting member. Thus, for instance, where shelves are supported by pins that extend from the vertical support members, those pins may be useable to support a suitably configured screen and reflecting member. Here, where the pin heights along the lengths of the vertical supports are adjustable, screen height may be modified by altering the heights of screen supporting pins. Other coupling configurations are contemplated (e.g., tracks, pins extending from the screen/reflecting member and receivable in vertical supports slots, etc.).

As another instance, in at least some embodiments, a display screen and a reflecting member are used to form an easel where a rear surface of the reflecting member and a front surface of the screen face outwardly while a reflecting surface of the reflecting member generally faces the rear surface of the screen. Here, the easel can be used to provide the typical supporting functions associated with an easel or, where a projector is added to the assembly and arranged properly with respect to the reflecting surface, to provide a rear projecting assembly.

In some cases the screen may be completely removable from the supporting structure while, in other cases, the display member may be semi-permanent and useable to facilitate at least one function when the support structure is used for its normal use. For instance, in some embodiments where the structure is an easel, a conventional whiteboard may be swappable for the rear projection screen while in other embodiments the screen may comprise a translucent whiteboard material so that the screen is useable as a whiteboard, a projection display, or both. As another instance, in some embodiments where the structure includes vertical shelf supports, the screen may be completely removable to facilitate unfettered access to the shelf space while in other embodiments the screen may comprise a sliding shelf door member that slides about on a track to restrict or allow access to the shelf space.

In cases where the screen includes a writable/erasable front surface and is removable from the supporting structure, the screen may be used as a conventional whiteboard in any environment and separate from the reflecting member and the projector. In addition, with at least certain projectors, the projector may be used separately from the screen and reflecting member as a front projector with a conventional front projecting screen.

Consistent with the above, at least some of the inventive embodiments include a convertible projection assembly comprising at least a first support member including at least a first portion adjacent a projecting space that is bound on a first side by a screen receiving space, at least a first accessory member removably supportable by the first portion so as to reside substantially within at least one of the projecting space and the screen receiving space, the first accessory member removable from the at least one of the projecting space and the screen receiving space to provide a substantially unobstructed space, a screen member including oppositely facing front and rear surfaces, the screen member releasably supportable by the support member within the screen receiving space with the front surface at least partially vertically oriented and a projector unit supportable by the support member outside the projecting space to project an image, when the first accessory member is removed from the at least one of the projecting space and the screen receiving space, the projected image passing through the projecting space and subtending the rear surface of the screen member.

In addition, some embodiments include a shelving and display assembly for use with a projector unit that projects a projection image along a trajectory, the assembly comprising a shelving assembly including at least first and second support members and a plurality of shelf members supportable substantially within a projecting space by the support members, at least a first sub-set of the shelf members removable from the projecting space to form an essentially unobstructed projecting space bound on one side by a screen receiving space, a projection screen member including oppositely facing front and rear surfaces, the screen member releasably mountable to the first and second support members within the screen receiving space with the front surface at least partially vertically oriented, a reflecting member including a reflecting surface, when the sub-set of shelf members is removed from the projecting space, the reflecting member supportable by at least one of the screen member and the support members at least partially within the projecting space with the reflecting surface forming an angle with the rear surface and a projector support member linked to at least one of the support members and forming at least one surface for supporting the projector unit outside the projecting space, wherein, when the first sub-set of the shelves is removed from the projecting space and the projecting unit is received on the projector support member, an image projected by the projector unit is reflected off the reflecting surface and passes through the projecting space toward the rear surface of the screen member.

Some embodiments include a projector screen assembly for use with a projector unit and a support structure, the projector unit supportable by the support structure for projecting a projection image along a projection path, the assembly comprising a screen assembly including a projection screen member including oppositely facing front and rear surfaces and a screen edge and a reflecting member including a reflecting surface, the reflecting member mounted to the screen member along the screen edge with the reflecting surface facing at least partially in the direction of the rear surface, wherein, the screen assembly is releasably mountable to the support structure such that the front surface is at least partially vertically oriented, the reflecting surface is at least partially within the projection path and reflects the projected image along a reflected path and the rear surface forms an angle with the reflecting surface such that the reflected image is directed at the rear surface.

Moreover, some embodiments include an easel-screen assembly comprising an easel support structure at least in part defining a projecting space bound on one side by a screen receiving space, a reflecting member mounted to the easel support structure along one boundary of the projecting space, the reflecting member including an at least partially reflecting internal surface facing the projecting space and an oppositely facing external side, the external side for presenting information and a translucent screen member including a front viewing surface and an oppositely facing rear surface, the screen member receivable within the screen receiving space such that the rear surface forms an angle with the reflecting surface.

Furthermore, some embodiments include an easel-screen assembly for use on a substantially flat ambient surface, the assembly comprising an easel support structure, a translucent screen member including a viewing front surface and an oppositely facing rear surface, a reflecting member forming an internal surface and an oppositely facing external surface, the internal surface of the reflecting member at least in part forming a reflecting surface, wherein, the first and second planar members are mounted to the support structure on opposite sides of a projecting space with the rear surface facing the reflecting surface, the front surface forming an acute angle with the ambient surface and the rear surface forming an acute angle with the reflecting surface.

In addition, at least some embodiments include a convertible projection assembly comprising a support structure, a translucent screen member including a viewing front surface and an oppositely facing rear surface, the screen member releasably mountable to the support structure and a reflecting member forming an internal surface and an oppositely facing external surface, the internal surface of the reflecting member at least in part forming a reflecting surface, the reflecting member releasably mounted to the support structure such that the reflecting surface at least in part faces the rear surface of the screen member.

Moreover, the invention also contemplates a method for use with a shelf assembly including an upright support structure and a plurality of removable shelves that are supportable by the support structure in substantially horizontal juxtapositions within a projecting space, the method for converting a shelf assembly to a rear projection assembly and comprising the steps of removing the shelves from within the projecting space, supporting a screen member on the upright support structure with a front screen member surface substantially vertically upright and supporting a reflecting member having a reflecting surface via at least one of the support structure and the screen member with the reflecting surface forming an angle with the screen member surface and positioning a projector unit with respect to the reflecting surface so that the a projected image from the projector is directed along a trajectory that reflects off the reflecting surface and toward the rear surface of the screen member.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a perspective view of a convertible shelf-projection assembly in a projection configuration according to an exemplary inventive embodiment;;

FIG. 2 is a perspective view of the assembly of FIG. 1, albeit configured to operate as a shelving unit;

FIG. 3 is a front plan view of the shelving configuration of FIG. 2;

FIG. 4 is a partial cross-sectional view taking along the line 4-4 of FIG. 3;

FIG. 5 is a partial cross-sectional view similar to the view of FIG. 4, albeit illustrating the assembly components in an intermediate configuration;

FIG. 6 is a front plan view similar to the view of FIG. 3, albeit illustrating the assembly in the projection configuration;

FIG. 7 is similar to the partial cross-sectional view of FIG. 4, albeit illustrating the assembly in the projection configuration;

FIG. 8 is a perspective view of a pin assembly according to at least one embodiment of the present invention;

FIG. 9 is a front plan view similar to the view of FIG. 6, albeit illustrating a second shelf/projection assembly in a projecting configuration;

FIG. 10 is a partial cross-sectional view taken along the line 10-10 of FIG. 9;

FIG. 11 is a perspective view of the reflecting side of the reflecting member of FIG. 10;

FIG. 12 is a perspective view of the rear side of the screen member of FIG. 10;

FIG. 13 is an enlarged partial view of the track assembly of FIG. 10;

FIG. 14 is a front plan view of a third shelf/projection assembly where a display screen is mounted for sliding movement to the front of two shelving stacks;

FIG. 15 is a cross-sectional view taken along line 15-15 in FIG. 14;

FIG. 16 is an enlarged partial view of the track assembly of FIG. 15;

FIG. 17 is a front plan view of yet another inventive embodiment that takes the general form of an easel;

FIG. 18 is a perspective view of the embodiment of FIG. 17 including different board members that can be used with the easel assembly;

FIG. 19 is a cross-sectional view taken along line 19-19 in FIG. 17;

FIG. 20 is another easel embodiment including a permanent projection screen;

FIG. 21 is one other easel embodiment where an entire front easel member is translucent and operates s a projection screen;

FIG. 22 is a perspective view of a cubical environment wherein an exemplary rail mounted screen member consistent with at least one aspect of the present invention is illustrated;

FIG. 23 is a front plan view of a storage cart mounted assembly according to another embodiment of the present invention;

FIG. 24 is a side plan view of the assembly of FIG. 23;

FIG. 25 is a perspective view an open easel/projecting assembly;

FIG. 26 is a perspective view an open easel/projecting assembly including a projecting unit support assembly; and

FIG. 27 is a perspective view of an open easel/projecting assembly including an adjustable reflecting member, plastic cover member and substantially vertical viewing screen.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Hereinafter, several exemplary embodiments of the present invention are described, each having certain distinguishing features. Nevertheless, it should be apparent that certain of the features may be useable in several of the embodiments.

### First Embodiment

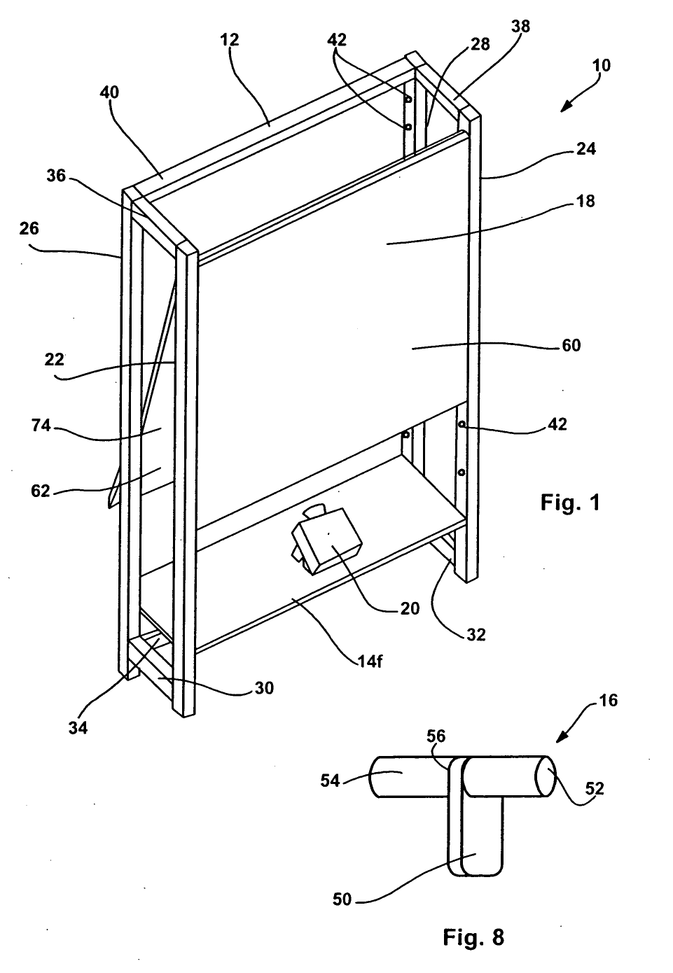

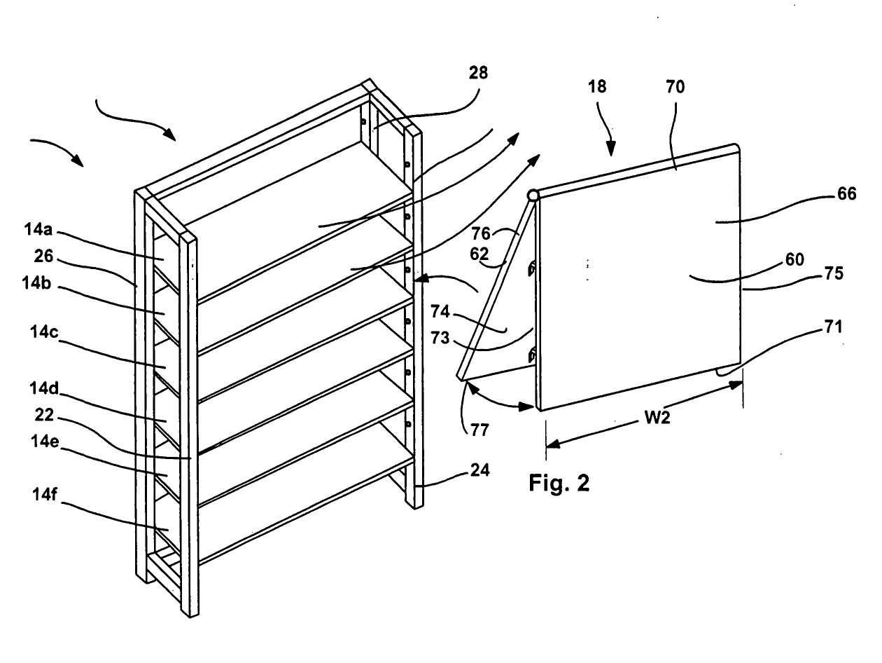

Referring now to the drawings wherein like reference numeral correspond to similar elements throughout the several views and, more specifically, referring to FIGS. 1 through 8, a first embodiment of the present invention will be described in the context of a shelf-projection assembly 10 that, as its label implies, is convertible between a shelving configuration (see FIG. 2) and a rear projecting configuration (see FIG. 1). To this end, shelf-projection assembly 10 includes a support structure generally identified by numeral 12, a plurality of shelf members 14a through 14f (see FIG. 2) (i.e., accessory members), a plurality of pin assemblies, several of which are identified by numeral 16, 16a, 16b, etc., in the figures, a screen-reflector assembly 18 and a projector unit 20.

Support structure 12 is formed of a rigid material such as steel or aluminum. In the illustrated embodiment, structure 12 includes four upright or vertical support members 22, 24, 26 and 28, and six horizontal support members 30, 32, 34, 36, 38 and 40. The four vertical support members 22, 24, 26 and 28 are arranged to form first and second spaced apart pairs including a front pair 22 and 24 and rear pair 26 and 28. Front pair 22 and 24 are spaced apart such that facing surfaces 43 and 45 thereof define a shelf width dimension W1. Rear pair 26 and 28 are similarly spaced to define dimension W1. Front pair 22 and 24 are spaced apart from rear pair 26 and 28 so that vertical members 22, 24, 26 and 28 form a rectangle when viewed from the top. Front pair members 22 and 24 include flat front facing surfaces 57 and 59, respectively.

Three of the horizontal support members 30, 32 and 34 are rigidly secured proximate the lower ends of vertical members 22, 24, 26 and 28 so as to maintain the relative juxtapositions of those lower ends. More specifically, horizontal member 30 is rigidly secured between the lower ends of vertical members 22 and 26 and horizontal member 32 is secured between the lower ends of vertical members 24 and 28. Horizontal member 34 is rigidly secured between horizontal members 30 and 32 to maintain their relative juxtapositions. Horizontal members 36, 38 and 40 are rigidly secured to the top ends of vertical members 22, 24, 26 and 28 to maintain the relative juxtapositions of the vertical members. More specifically, horizontal member 36 is rigidly secured between the top ends of vertical members 22 and 26, horizontal member 38 is rigidly secured between the top ends of vertical members 24 and 28 and horizontal member 40 is rigidly secured between the top ends of vertical members 26 and 28.

Referring to FIGS. 1, 6 and 7, each vertical member 22, 24, 26 and 28 forms a plurality of holes or apertures, several of which are collectively identified by numeral 42 throughout the figures. Holes 42 are generally equispaced along the lengths of the support members, are formed in the facing surfaces (e.g., 43, 45) of the vertical members and are spaced such that each of the holes is at the same height as one other hole formed by each of the other vertical support members. Holes 42 formed in members 22 and 24 face each other while holes formed in members 26 and 28 likewise face each other.

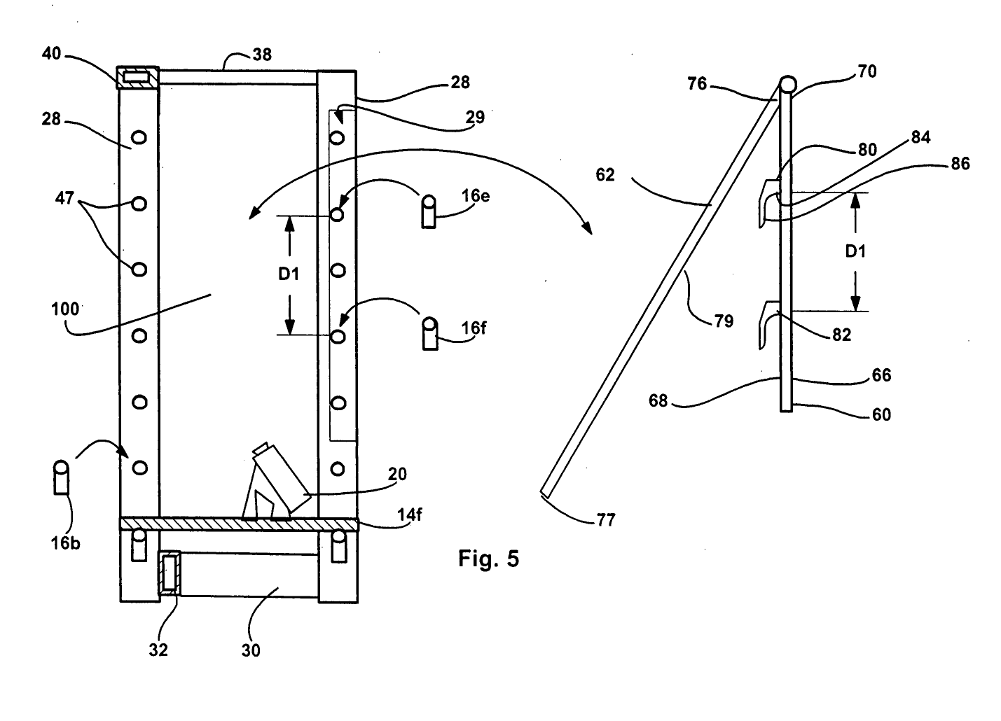

As best seen in FIG. 5, in the illustrated embodiment, a dimension D1 is defined by two of the holes formed by support member 24. Generally, the holes that define dimension D1 will include one near the top of member 24 and one hole approximately midway between the ends of member 24. Similarly formed holes in each of members 22, 26 and 28 likewise define dimension D1 at a similar horizontal height.

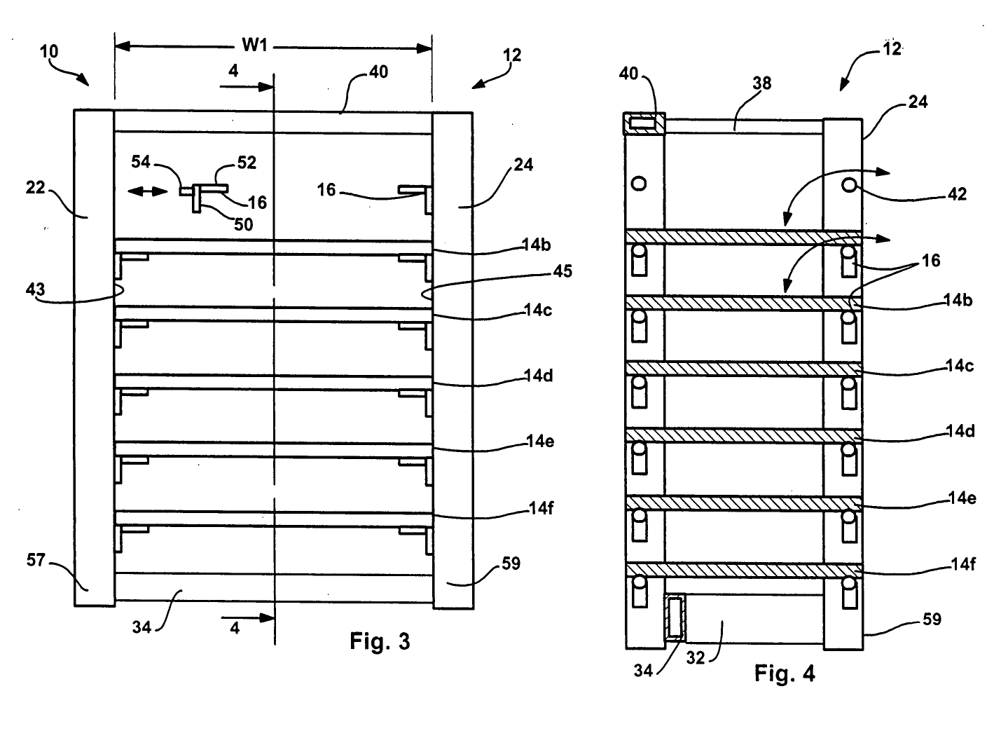

Referring now to FIGS. 3, 4 and 8, each pin member 16 (also referred to as a coupler member) includes three integrally formed rigid components including a flat based member 50, a shelf supporting pin 52 and a rear extending pin 54. Shelf supporting pin 52 and rear extending pin 54 extend from opposite sides of flat member. Rear extending pin 54 is sized and shaped to so as to be receivable within one of holes 42 formed by upright support members 22, 24, 26 and 28. When pin 54 is received in one of holes 42, a rear surface 56 of member 50 rests on an adjacent surface (e.g., 43, 45) formed by the proximate vertical support member. When so positioned, shelf supporting pin 52 extends away from an associated vertical support member and toward another of the support members. In addition, when rear extending pin 54 is received in one of the holes 42 and when a force or a weight is applied to the top edge of shelf supporting pin 52, the rear surface 54 of flat member 50 acts a fulcrum to maintain supporting pin 52 in a single supporting position with pin 52 substantially horizontal.

Referring now to FIGS. 2, 3 and 4, each shelf member 14a through 14f is a planar rectilinear rigid member which is sized so as to be receivable in a horizontal orientation within the rectilinear space defined by vertical support members 22, 24, 26 and 28. When four pin members 16 (see again FIG. 8) are coupled to four of holes 42 formed by vertical support members 22, 24, 26 and 28 where the holes are at the same height, one of the shelf members (e.g., 14a) may be positioned on the top edges of the shelf supporting pins 52 to be supported thereby.

Although not illustrated, in at least some embodiments, it is contemplated that grooves may be provided on the undersurface of each shelf for receiving the top edges of shelf supporting pins 52. In other embodiments it is contemplated that the top edges of pins 52 may be flattened to better support the undersurface of a shelf support thereby and that the pins 54 that extend into holes 42 may have more unique structure to better engage the holes. Indeed, in some embodiments the pins may be permanently secured to the support members 22, 24, 26 and 28 while in other embodiments slots may be provided in the support members while pins that are receivable by the slots are integrally formed at the ends of and extend from the shelf members 14a-14f.

At this point, it should be appreciated that the assembly described above is configurable to provide a full shelving configuration as illustrated in FIG. 2. Here, shelf heights and relative juxtapositions of shelf members with respect to other shelf members may be altered by removing a shelf from the support structure 12, removing shelf supporting pins 16, placing the shelf supporting pins in other sets of holes 42 and then replacing one of the shelf members on the pins.

Referring now to FIGS. 1, 2, 5, 6 and 7, screen-reflector assembly 18 includes a screen member 60 and a reflecting member 62. Screen member 60 is a planar, rectilinear and, in this embodiment, rigid member having front and rear surfaces 66, 68, respectively, top and bottom edges 70 and 71 respectively, and first and second lateral edges 73 and 75, respectively. Lateral edges 73 and 75 define a width dimension W2 that is similar (e.g., slightly less than) width dimension W1 formed by the facing surfaces 43 and 45 of support members 22 and 24 such that member 60 is receivably between members 22 and 24 with edges 73 and 75 adjacent facing surfaces 43 and 45, respectively.

Screen member 60 is formed of a translucent material such that images and information that are projected onto rear surface 68 are viewable by an assembly user viewing front surface 66. In some embodiments, front surface 66 of member 60 will be formed of a writable/erasable material wherein erasable marker pens are useable to manually apply information to surface 66. Here, surface 66 may be useable as an erasable whiteboard tool to present information.

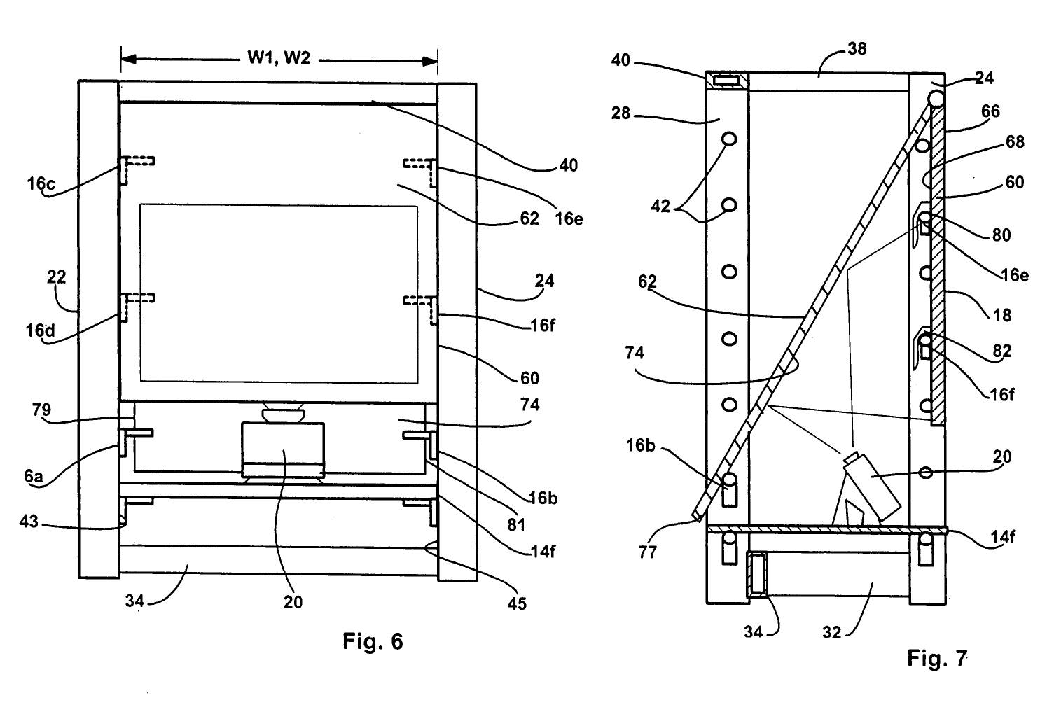

Reflecting member 62 comprises a rigid rectilinear member having a front reflecting surface 74, top and bottom edges 76 and 77, respectively, and first and second lateral edges 79 and 81 (see FIG. 6), respectively. Although not separately labeled, in this embodiment, reflecting member 62 has a width dimension that is slightly less than width W1 of screen member 60 so that member 62 is receivably between the facing surfaces (e.g., 43, 45) of the vertical support pairs. In this first embodiment, top edge 76 of reflecting member 62 is mounted or secure to the top edge 70 of screen member 60. In some embodiments reflecting member 62 will be rigidly mounted to screen member 60 while, in other embodiments, it is contemplated that reflecting member 62 may be pivotally mounted to the top edge of screen member 60 such that, as best illustrated in FIGS. 2 and 5, reflecting member 62 may be pivoted toward and away from rear surface 68 of screen member 60. Here, in at least some embodiments, the pivotal connection between members 60 and 62 will be such that member 62 may be pivoted into a substantially parallel relationship with member 60 to facilitate easy storage of assembly 18 in a substantially flat configuration.

Referring now to FIGS. 2, 5 and 7, in this first embodiment, a set of slot members extend from screen member 60 for mounting screen member 60 to pin members 16 coupled to holes in the front pair of vertical support members 22 and 24. More specifically, in the illustrated embodiment, a first upper slot member 80 and a first lower slot member 82 extend from rear surface 68 of screen member 60 at different points along first lateral screen edge 73. As the labels imply, upper slot member 80 is positioned at a location that is relatively higher than lower slot member 82 during use of the screen-reflector assembly 18. Similarly, although not illustrated, a second upper slot member and a second lower slot member are provided that extend from rear surface 68 at different points along second lateral edge 75 of screen member 60. Each of the slot members has a similar construction and operation and therefore, in the interest of simplifying this explanation, only slot member 80 will be described here in detail.

Slot member 80 is a rigid member that forms a downwardly opening slot 84 sized to receive one of shelf supporting pins 52 (see again FIG. 8). The surface 86 of member 80 facing rear surface 68 may be sloped from a distal end of member 80 toward rear surface 68 so as to guide a supporting pin 52 into slot 84 during a mounting process.

Referring still to FIG. 5, the upper and lower slot members 80 and 82 along each of the lateral edges are spaced apart such that a dimension D2 between the slots along a common edge is essentially identical to dimension D1 defined by holes in member 24 as described above (see again FIG. 5).

Projector unit 20 is a conventional projector type assembly as known in the art and therefore will not be described herein detail. Here, it should suffice to say that unit 20 may be a dedicated rear projection type assembly or may be a front-rear projector useable in different modes for various projection purposes.

Referring now to FIGS. 1, 2, 5, 6 and 7, it should be appreciated that the assembly above can be, and is intended to be, converted from the shelving configuration as illustrated in FIG. 2 to a rear configuration assembly as illustrated in FIGS. 1, 6 and 7. To this end, an upper sub-set of the shelf members (e.g., 14a-14e) and associated pins 16 may be removed from the top ends (i.e., first or upper portions) of support members 22, 24, 26 and 28 thereby creating an essentially unobstructed space. The space formed when shelf members and pins are removed will be referred to herein as a “projecting space” 100. In addition, referring to FIG. 5, a space 29 that receives screen member 66 bounds projecting space 100 on a first side. Hereinafter the bounding space 29 will be referred to as a “screen receiving space” unless indicated otherwise.

Next, two pins 16a and 16b are recoupled to holes 20 formed by rear pair 26 and 28 near the lower ends of projecting space 100. In the illustrated embodiment (see FIG. 6), one pin 16a is received in the hole 20 just above remaining shelf member 14f formed by support member 26. Similarly (see also FIG. 6), one pin 16b is received in the hole 20 just above shelf member 14f formed by support member 28.

Continuing, assembly 18 is retrieved from storage and is positioned in the juxtaposition illustrated in FIG. 7 where the lower end of reflecting surface 74 proximate edge 77 rests on the shelf supporting pins 52 of the pin members 16a and 16b previously coupled proximate the lower ends of support members 26 and 28. Assembly 18 is lifted such that slots formed by slot members 80 and 82 are proximate holes formed by vertical support members 22 and 24 with viewing surface 66 flush with the front surfaces 57 and 59.

Next, four pin members 16 are re-coupled to the front pair of vertical support members 22 and 24 as illustrated best in FIG. 6. More specifically, two pins 16c and 16d are received within the two holes 20 that define dimension D1 in member 22 while two pins 16e and 16f are similarly received in the two holes 20 that define dimension D1 in member 24. After the pin members have been coupled to support members 22 and 24, screen-reflector assembly 18 is moved downward until each of the shelf supporting pins 52 of members 16c through 16f are received in a proximate one of the slots 84 formed by slot members 80 and 82. At this point, the screen-reflector assembly 18 is fully supported by pins 16a-16f and the support structure 12 with screen member 60 positioned for viewing within screen receiving space 29.

Referring to FIGS. 1, 6 and 7, projector unit 20 is next positioned in a lower space on the lower remaining shelf member 14f such that projector 20 projects images along a trajectory that is directed toward reflecting surface 74. The relative juxtapositions of projector 20 and reflecting surface 74 are adjusted by either moving the projector 20 or adjusting the angle of reflecting surface 74 with respect to rear surface 68, or both. After adjusting the relative juxtapositions of projector 20 and surface 74, images and information projected toward surface 74 should reflect therefrom and subtend rear surface 68 of screen member 60.

When assembly 10 is assembled in the rear projector configuration, assembly 10 can be used in several different ways. First, where surface 66 is rigid and is writable/erasable, assembly 10 may be used as a conventional whiteboard to manually apply information to and present information on surface 66 without using projector unit 20. Second, unit 20 may be employed to project information and information may be simultaneously added to surface 66 via an erasable pen.

In some cases where information is manually added to surface 66, an additional assembly (not illustrated) may be used to capture the added information for digital storage. Systems for capturing information from a board surface including camera systems and instrument sensing systems are known in the art and therefore are not described here in detail. Here, it should suffice to say that an exemplary system for capturing information is described in the pending U.S. application titled “Electronic Whiteboard” that has been incorporated above. Here it is contemplated that some embodiments may include sensing configurations.

Although experiments have shown that in many office and shared space environments typical projector units 20 project images that are sufficiently bright that no additional structure is required to enclose the projecting space 100 to generate good images, in at least some cases it is contemplated that some type of side light blocking shroud may be provided to generate even better projected images.

Referring again to FIG. 5, it is contemplated that many hole 42 pairs along each of members 22, 24, 26 and 28 will define dimension D1 so that assembly 18 may be mounted at various heights to facilitate optimal viewing given specific circumstances. Here, raising the screen 60 is a simple task that requires minimal effort because the system components are separate and each separate component is relatively light weight and easily de-coupled from and recoupled to the supporting structure.

### Second Embodiment

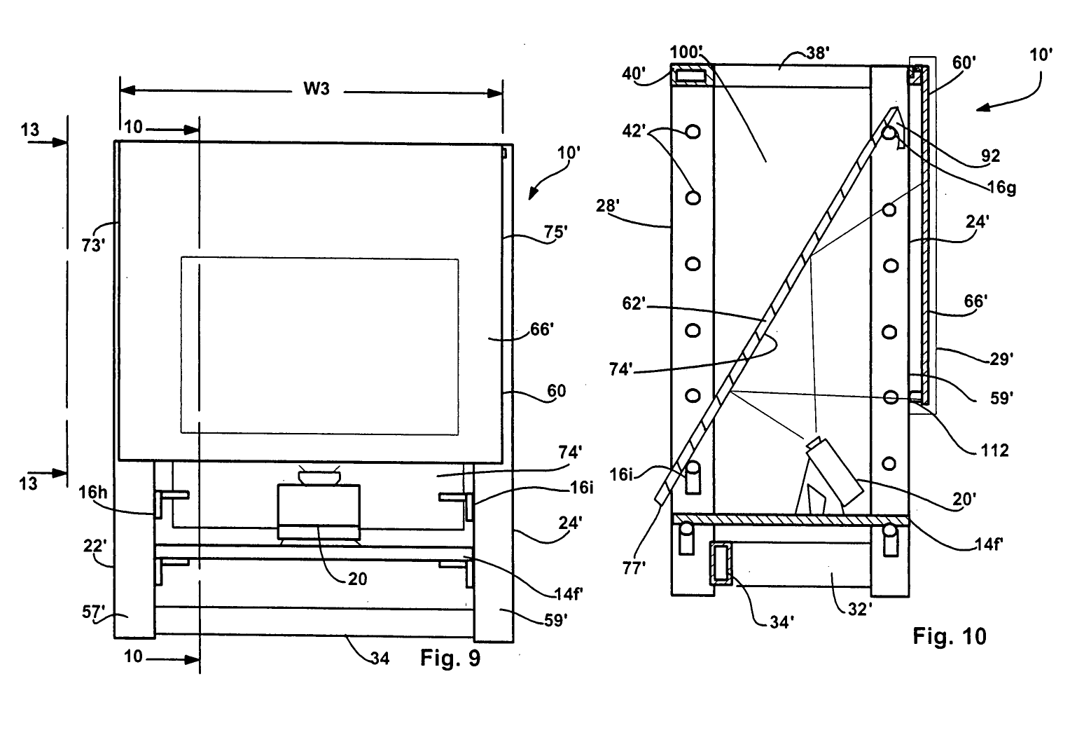

Referring now to FIGS. 9 through 13, a second embodiment of the present invention is illustrated. This second embodiment is similar to the first embodiment in many respects and therefore, in the interest of simplifying this explanation, only differences between the first and second embodiments will be described here in detail. Components in this second embodiment that are similar to the components described above with respect to the first embodiment are identified by similar numbers herein followed by a prime (i.e., “′”).

In general, there are three primary differences between the first and second embodiments. First, instead of providing a single assembly 18 that includes both the screen member and the reflecting member, in this second embodiment, the screen member is separate from the reflecting member and the screen member and reflecting member mount separately to the support structure 12. Second, the mounting structure for the screen member in this second embodiment is different than the mounting structure described above with respect to the first embodiment. Third, the mounting structure for the reflecting member is different.

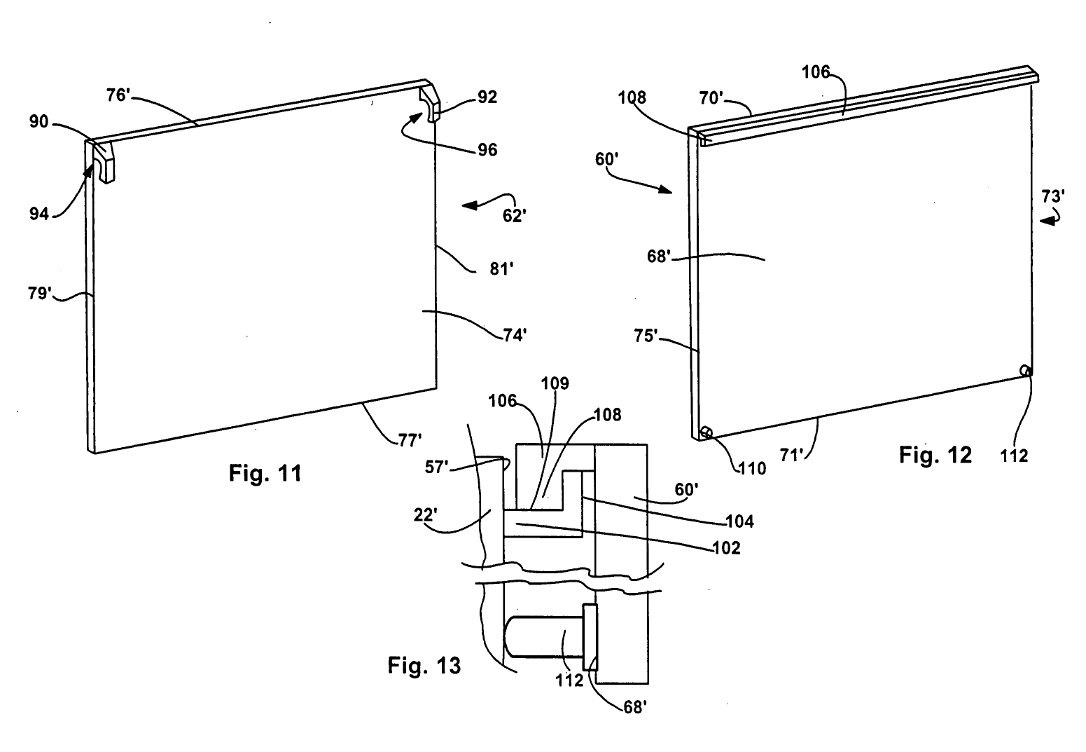

Referring to FIGS. 10 and 11, reflecting member 62′ includes first and second slot members 90 and 92. Slot member 90 extends from reflecting surface 74′ proximate the corner formed by lateral edge 79′ and top edge 76′. Similarly, slot member 92 extends from rear surface 74′ proximate the corner formed by a second lateral edge 81′ and top edge 76′. Each of the slot members 90 and 92 generally extend in the direction of lower edge 77′ so as to form a downwardly opening slot 94, 96 when reflecting member 62′ is positioned in a functional orientation as illustrated in FIG. 10. Each of the slots 94 and 96 is formed to receive a separate one of the shelf supporting pins 52 described above. Member 62′ has width and height dimensions that are similar to the dimensions of member 62 described above.

Referring to FIGS. 10 and 13, a rigid elongated L-shaped track 102 is mounted to the front faces 57′ and 59′ and top ends of vertical support member 22′ and 24′ and traverses the distance therebetween. The L-shaped member 102 includes an upwardly extending rib member 104 that is substantially parallel to the front faces of members 22′ and 24′. Faces 57′ and 59′ and the facing surfaces of member 104 form a channel 109.

In this embodiment, a second L-shaped track member 106 is secured to the rear surface 68′ proximate top edge 70′ of screen member 60′ and forms a rib member 108 that extends toward bottom edge 71′. Rib 108 is dimensioned to be receivable within channel 109. Two limiting members 110 and 112 are provided on the rear surface 68′ of screen member 60′, a separate limiting member 110, 112 positioned at each of the lower corners of member 60′. In at least some embodiment limiting members 110 and 112 include a rubber distal end.

Referring still to FIG. 9, in the illustrated embodiment screen member 60′ has a width dimension W3 that is greater than the width dimension W1 formed by facing surfaces of support members 22 and 24. For instance, when member 60′ is placed adjacent members 22 and 24, 43′ and 45′ each of lateral edges 73′ and 75′ may extend past a proximate facing surface of a proximate member 22, 24 by one to two inches.

Referring now to FIG. 10, after shelf members and pin members 16 have been removed from the upper portions of the vertical support members (e.g., 28 and 24) so that there is a substantially unobstructed projecting space 100′ between the vertical support members, screen receiving space 29′ bounds the unobstructed space 100′ on a first side. Four pin members are next recoupled to the vertical support members to supporting reflecting member 62′. To this end, separate pin members 16g (only one shown) are coupled to each of the front vertical support members 22 and 24 near their upper ends while separate pin members 16h and 16i are coupled to each of the rear vertical support members 26 and 28 near their lower ends as best illustrated in FIGS. 9 and 10. Next, reflecting member 62′ is manipulated into the position illustrated in FIG. 10 where the pin members (e.g., 16g) coupled to front support members 22 and 24 are received within slots 94 and 96 and with the lower end of reflecting member 62′ resting on pins 16h and 16i that extend from rear support members 26 and 28.

Screen member 60′ is lifted up such that rib 108 is aligned above channel 109. Thereafter, screen member 60′ is moved downwardly until rib 108 is received in channel 109 as in FIGS. 10 and 13. When screen member 60′ is released, member 60′ hangs on L-shaped member 102 and limit members 110 and 112 rest on the front surfaces 57′ and 59′ of vertical support members 22′ and 24′ as illustrated. As above, unit 20 is added to the assembly and proper aligning adjustments are made to facilitate rear projection of images for viewing via surface 66′.

There are several advantages to this second embodiment. First, because screen member 60′ mounts to support members 22 and 24 independent of the holes 42 and pin members 16 used to support the shelf members 14a-14f and because none of the shelves extends into the screen receiving space 29′ when supported by members 22′, 24′, 26′ and 28′, screen 60′ may be supported by track 102′ and used as a whiteboard even while the shelf members remain supported within the projecting space. In fact, screen member 60′ may be useable with any L-shaped track member 102 regardless of whether or not a shelf stack exists therebehind.

Second, in some respects, because reflecting member 62′ is separate from screen member 60′, it will be easier to manipulate the assembly components. Similarly, the coupling assemblies in this embodiment should render the assembly task more manageable.

### Third Embodiment

According to a third embodiment of the present invention, a screen member similar to the screen members described above may be mounted on tracks to be moved laterally to any of several different positions with respect to an extended shelving assembly. Here, the screen member, when not being used for displaying projected images, may be used as a sliding door member or the like to hide materials therebehind.

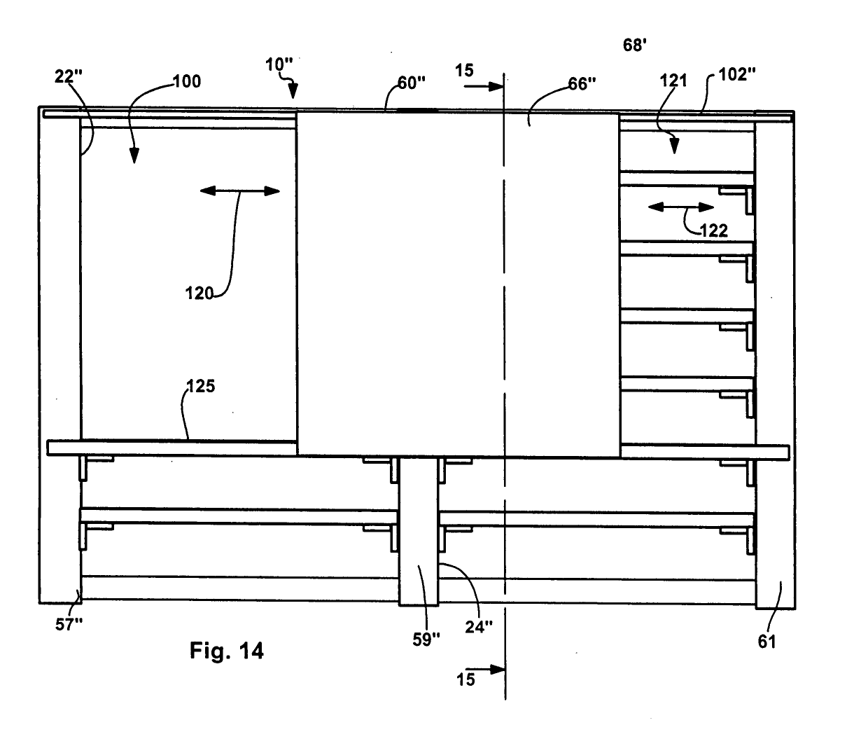

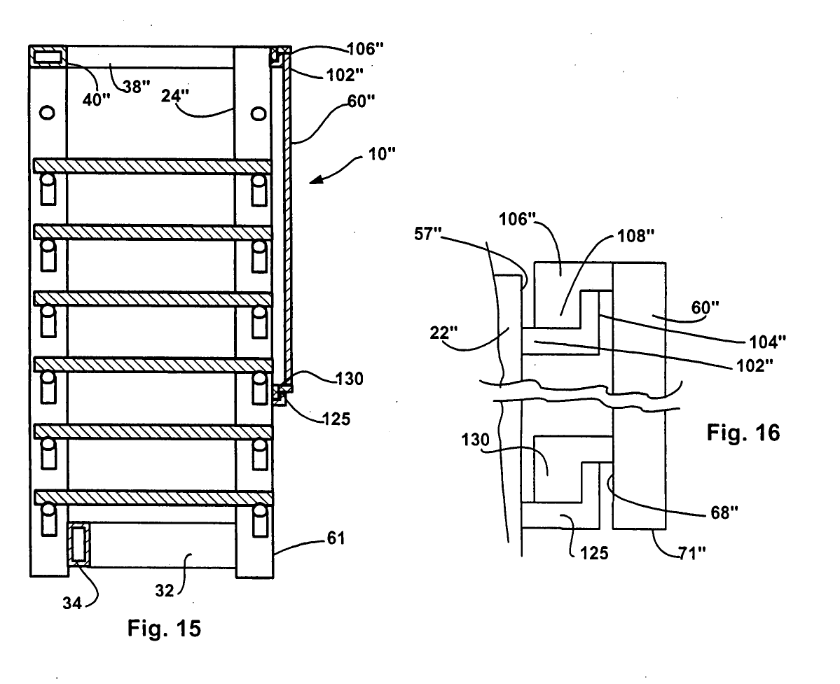

Referring now to FIGS. 14 through 16, a third embodiment 10″ of the present invention including a sliding screen member 60″ is illustrated. In this third embodiment, many of the components are substantially similar to the components described above with respect to the first two embodiments and therefore, in the interest of simplifying this explanation, will not be described here again in detail. Here, it should suffice to say that similar components are identified by similar numbers followed by a double prime (i.e., “″”).

The primary differences between this third embodiment and the second embodiment described above are that the third embodiment is used with two or more shelving stacks 126 and 128 that are arranged in a side-by-side orientation, the L-shaped track member 102″ extends along the entire width of the combined shelf stacks, a second “L” shaped track member 125 is mounted to the front surfaces 57″, 59″ and 61 of the stacks 126 and 128 below the first track member 102″ and a screen member 60″ includes a second “L” shaped extension 130 that extends along a lower edge 71″. Extension 130 mates with track member 125 when screen member 60″ is mounted to the stacks. Here, as indicated by arrows 120 and 122, screen member 60″ is movable along tracks 102″ and 125 so that the screen member 60″ is either aligned with first shelving stack 126 in a screen receiving space 100 or second shelving stack 128 in a storage space 121 adjacent screen receiving space 100.

In the illustrated embodiment, lower track 125 is mounted just above a set of the holes 42 formed by the stack support members (e.g., 22″ and 24″) so that track 125 does not impede use of any of the shelves when assembly 10″ is assembled as a shelving configuration. Here, as in the case of the second embodiment 10′, screen 60″ may be used with a projector unit 20 to display projected information or without a unit 20 as a whiteboard where surface 66″ is writable/erasable. Where screen member 60″ is used without a projector 20, all or a subset of the shelf members may be mounted within the projecting space 100.

While an embodiment is described above including upper and lower tracks 102″ and 125, at least some embodiments are contemplated that only include an upper track 102″ and members 110 and 112 (see again FIG. 12) may be placed at the lower corners of the rear surface of screen member 60″. In addition, other track and sliding assemblies are contemplated such as, for instance, ones where wheels or other friction reducing mechanical components are employed to facilitate sliding motion.

Referring to FIG. 22, an exemplary screen member 60″ consistent with this third embodiment is illustrated in a cubicle type environment 300 where a track 102″ runs along a top edge of a plurality of shelving stacks. FIG. 22 is provided as it is believed that a greater appreciation for at least some of the advantages of the present invention is obtainable by viewing the affects of the system in a typical small cubical space. In the illustrated case a relatively large viewing screen 66″ is configurable without requiring much room within the cubicle space.

### Fourth Embodiment

In addition to being able to advantageously convert a shelving configuration into a rear projection configuration in the manner described above, it has also been recognized that other structure commonly available within an office or other type shared environment can likewise be converted for use as a rear projection type assembly. To this end, more specifically, according to yet one additional aspect of the present invention, several types of easel/projection assemblies are contemplated wherein the configurations may be used either as a conventional easel configuration or, in the alternative, may be used as a projection type configuration.

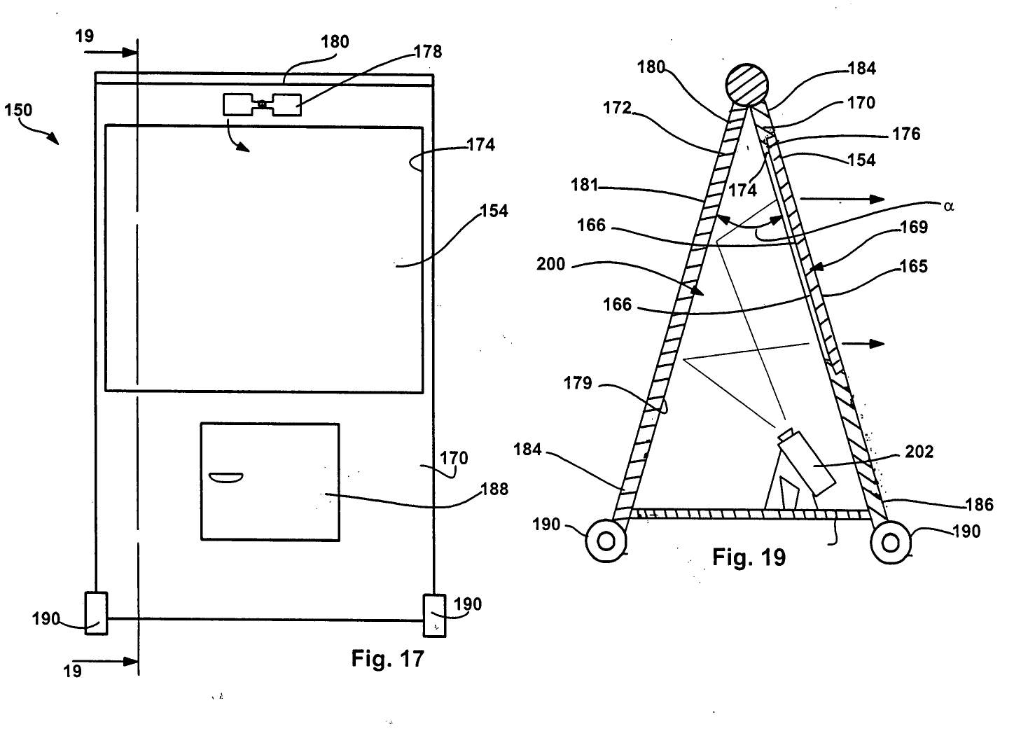

One easel/projection assembly 150 is illustrated in FIGS. 17-19 that is to be used on a substantially flat and generally horizontal ambient surface. In the exemplary embodiment, assembly 150 includes an easel support structure 152 and one or more screens or display boards that may be supported by the easel structure 152. In FIG. 17, two different types of screens or boards are illustrated including a translucent screen member 154 suitable for rear projection purposes and a more conventional whiteboard member 156. Here, while screen member 154 may have a front surface 165 suitable for writing and erasing via pens or the like, it is contemplated that board member 156 will have an optimal write/erase front surface 157. Thus, when projecting is not required, it will likely be advantageous to employ board member 156 as opposed to member 154 while screen member 154 will be necessary to facilitate rear projection.

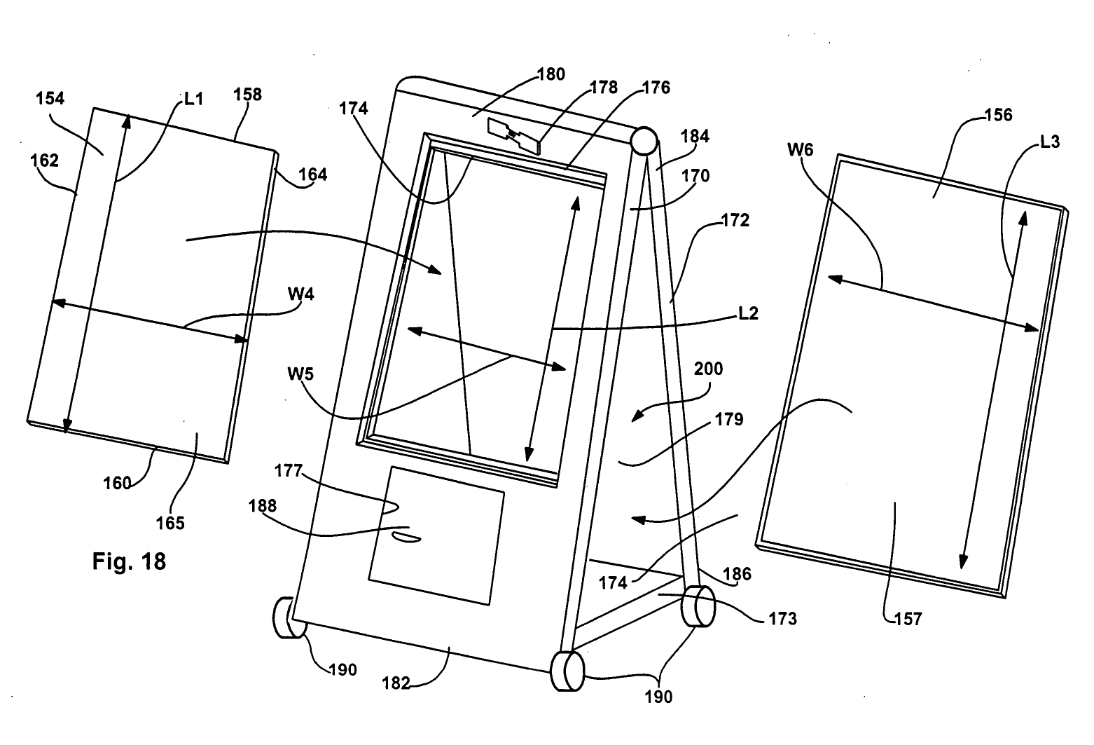

Referring specifically to FIG. 18, screen member 154 is a rigid planar and rectilinear member including top and bottom edges 158 and 160, respectively, and first and second lateral edges 162 and 164, respectively. Top and bottom edges 158 and 160 define a first length dimension L1 and lateral edges 162 and 164 define a width dimension W4. Member 154 includes oppositely facing front and rear surfaces 165 and 166 (see also FIG. 19), respectively.

Easel support structure 152 includes first and second partially vertical planar support members 170 and 172, a single horizontal member 173, a door member 188, a plurality of wheels or casters 190 and a locking member 178. First support member 170 is generally rectilinear including top and bottom edges 180 and 182, respectively, and lateral edges (not numbered). Member 170 forms first and second openings 174 and 177, respectively. Opening 174 has a width dimension W5 and a length dimension L2 that are slightly larger than the width dimension W4 and length dimension L1 of screen member 154 such that screen member 154 is receivable within opening 174. Member 170 has a thickness and forms a rib 176 that extends inwardly along the rear edge of opening 174 such that, when member 154 is placed within opening 174, rib 176 restricts passage therethrough and supports member 154 within opening 174 with front surface 165 flush with the front surface of member 170. Here the space formed by opening 174 that receives screen member 154 is referred to as a screen receiving space 169 which bounds a projecting space 200 (see FIG. 19) on a first side.

Referring still to FIGS. 17 and 18, locking member 178 is a butterfly type spinning component including two wings that extend from a central point where the central point forms an opening. Locking member 178 is mounted to the front surface of member 170 just above opening 174 via a screw or the like that passes through the hole formed by member 178. The wings of member 178 are dimensioned such that, when member 178 is rotated to at least one position about its mounting screw, at least one of the wings extends over opening 174. Thus, when screen member 154 is received in opening 174, member 178 can be rotated to restrict the top end of member 154 and impede displacement thereof.

Second opening 177 is below opening 174 and door member 188 is hingedly mounted therein. Although not illustrated, door member 188 may be swung open on its hinges to gain access to the projecting space between member 170 and 172.

Referring still to FIGS. 17-19, second easel support member 172 is a rigid rectilinear member including top and bottom edges 184 and 186, respectively and which includes internal and external surfaces 179 and 181, respectively. Internal surface 179 forms a reflecting or mirrored surface along at a least top part thereof and, at least in part faces opening 174. Easel support members 170 and 172 are mounted together at their top ends 180 and 184 and form an acute angle a as they extend downward therefrom. In the illustrated embodiment each of members 170 and 172 forms an acute angle with the ambient surface of between 60 and 75 degrees. In addition, in the illustrated example the angles between members 170 and 172 and the ambient surface are substantially identical. A separate wheel 190 is provided at the bottom corner of each of easel support members 170 and 172 to facilitate movement of assembly 150. Just above the wheels 190, horizontal member 173 is secured between easel support members 170 and 172 and forms a top support surface 174. Between easel support members 170 and 172 and the horizontal member 173, assembly 150 defines the projecting space 200 which is also useable as a storage space when the projector unit is not being used with other assembly components.

Referring still to FIG. 18, board member 156, like screen member 154, is a planar rigid and rectilinear member. Board member 156 has width and length dimensions W6 and L3 that are substantially identical to the width and length dimensions W4 and L1 of screen member 154 and has a similar thickness (not labeled). Thus, board member 156 may be placed within space 174 instead of screen member 154.

When one or the other of members 154 and 156 is not being used, if the projecting space 200 is not currently being employed for projecting purposes, the unused board 154 or 156 may be placed within space 200 for storage and transport.

Based on the above discussion, it should be appreciated that a versatile easel assembly 150 has been described which may be used in a conventional manner as a easel to support a conventional whiteboard writing surface, a pad of paper or some other presentation accessory or, in the alternative, may be used as a rear projection type assembly. To this end, referring to FIG. 18, to use assembly 150 as a conventional whiteboard easel, whiteboard member 156 secured within opening 174. In the alternative, to use assembly 150 as a rear type projecting assembly, whiteboard 156 is removed from opening 174 and screen member 154 is placed within opening 174. Thereafter, a projector 202 (see FIG. 19) may be placed on support surface 174 and angled toward reflecting surface 179 such that images projected thereby reflect off surface 179 and toward the rear surface 166 of screen member 154. Here, images can be viewed via surface 165.

Although not illustrated, in some embodiments, some type of clip member or other support or mounting member may be provided on the front surface of support member 170 to hold a pad of paper thereto or other presentation materials. Similarly, in at least some embodiments, additional mechanical structure is contemplated that may be added to the rear surface 181 of second support member 172 for holding a paper pad or the like thereon.

### Fifth Embodiment

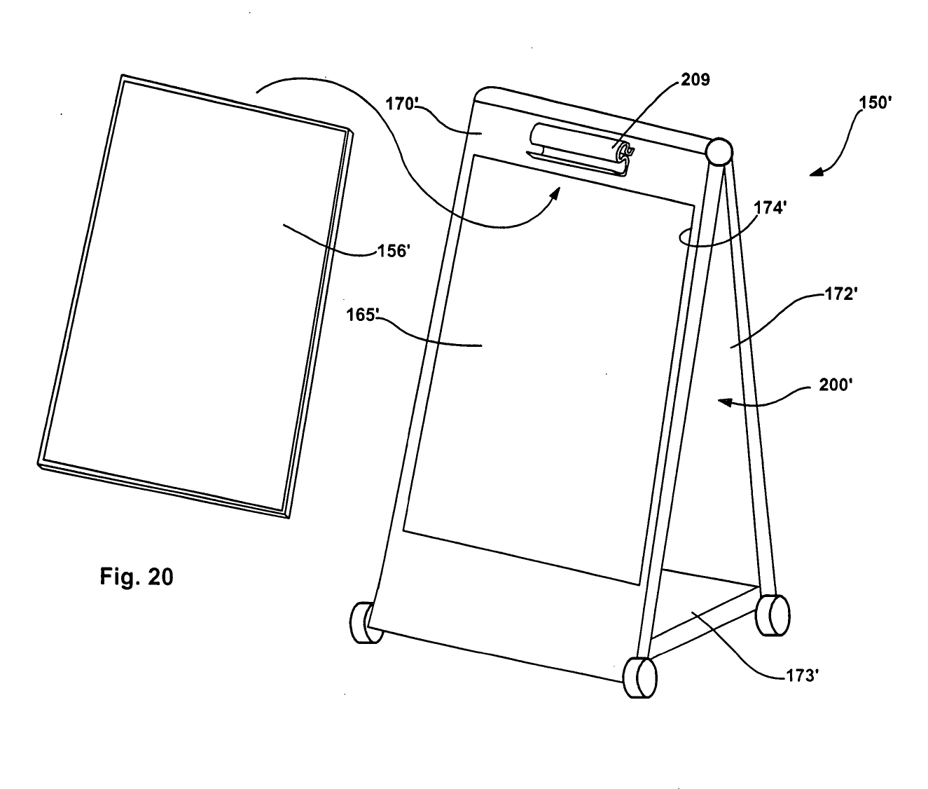

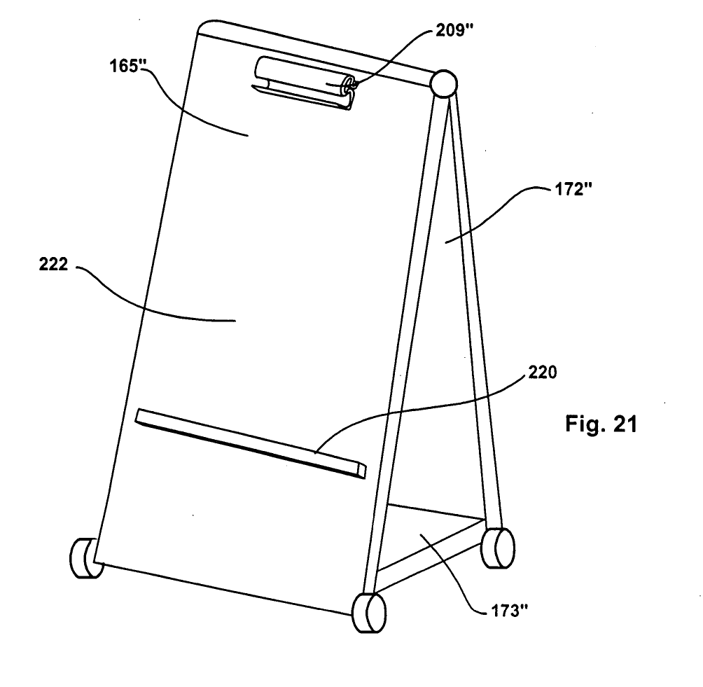

Referring now to FIG. 20, one additional easel/rear projection assembly 150′ is illustrated. Many of the components in the illustrated fifth embodiment are similar or identical to the components described above with respect to the fourth embodiment and therefore, in the interest of simplifying this explanation, will not be described again here in detail. Here, it should suffice to say that similar elements in this fifth embodiment will be identified by the same number used in the fourth embodiment followed by a prime (“′”).

The main difference between this fifth embodiment and the fourth embodiment is that a translucent rear projecting screen member 154′ is permanently positioned within an opening 174′ formed by the first easel support member 170′. Here, in some cases, no additional whiteboard member may be provided and instead the front surface 165′ of member 154′ may be a writable/erasable surface. In the alternative, whether or not surface 165′ is writable/erasable, an additional whiteboard member 156′ may be provided that can be secured via a board coupler (e.g., a clip member 209) or the like mounted at the top end of member 170′ or supported over front surface 165′ to facilitate conventional write/erase functionality.

### Sixth Embodiment

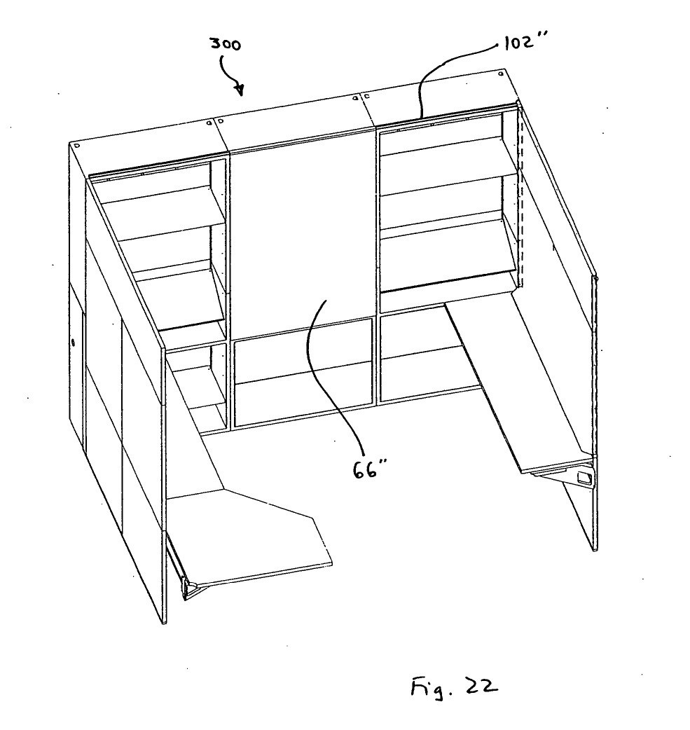

Referring now to FIG. 21, one additional easel/rear projector assembly 150″ is illustrated. In this sixth embodiment many of the components are similar to the components described above with respect to the fourth embodiment and, once again, those components are not described here in detail in order to simplify this explanation. Here, it should suffice to say that similar components are identified by the same number used with respect to the fourth embodiment followed by a double prime (i.e., “″”).

The primary difference between this sixth embodiment and the fourth embodiment described above is that first easel support member 170″ is replaced by a translucent member 222 which is suitable for displaying rear projection images. Thus, entire member 222 is formed of the same material and can pass rear projection images. In at least some cases, it is contemplated that the portion of member 222 that will pass projected images may have a reduced thickness so that clear images are projected while member 222 still provides sufficient support to other easel components. In FIG. 21 a tray 220 is provided below the portion of member 222 that will pass images to receive accessories and support other components (e.g., in some cases, a conventional whiteboard) thereabove.

### Seventh Embodiment

Referring now to FIG. 25, yet one additional easel/projector assembly 350 is illustrated wherein the easel assembly has a relatively open configuration. To this end, assembly 350 includes a support structure 352, a translucent rear projecting screen member 354, a reflecting member 356, a single horizontal support member 360 and a projector unit 358. Support structure 352 includes four substantially upright support members or bars 370, 372, 374 and 376. The support members include a front pair 370 and 372 and a rear pair 374 and 376. Front pair 370 and 372 are spaced apart and are substantially parallel to each other. Similarly, rear pair 374 and 376 are space apart and parallel to each other. Members 370 and 374 are integrally connected together at their top ends and diverge from one another as they extend downwardly. Similarly, support members 372 and 376 are integrally connected at their top ends and diverge from one another as they extend downwardly. Separate wheels or casters 362 are provided at the bottom ends of each of members 370, 372, 374 and 376 to facilitate transport of assembly 350 within a facility.

Horizontal member 360 is mounted proximate the lower ends of members 370, 372, 374 and 376 just above wheels 362 and forms a substantially horizontal support surface 361. Projector unit 358 is positionable on surface 361 so as to direct images generally upwardly and toward the space between second support pair 374 and 376.

Referring still to FIG. 25, screen member 354 is a rectilinear screen member and is mounted between the top portions of support members 370 and 372 such that a front viewing surface 355 faces away from support members 374 and 376. Reflecting member 356 is a rigid rectilinear member which is mounted between the top portions of support members 374 and 376 and includes an internal reflecting surface 365 that generally faces in the direction of screen member 354. A tray 378 is provided along the bottom edge of screen member 354 for holding accessories. Similarly, a tray 379 is provided along the bottom edge of the external surface (not labeled) of reflecting member 356 for holding accessories.

As illustrated, projecting unit 358 is positionable such that images projected thereby reflect off surface 365 and toward the rear surface (not labeled) of screen member 354 such that the images are viewable on front surface 355. As in the above embodiments, here surface 355 may be a writable/erasable surface such that, in addition to facilitating rear projection viewing, surface 355 also facilitates manual application of information for sharing purposes.

### Eighth Embodiment

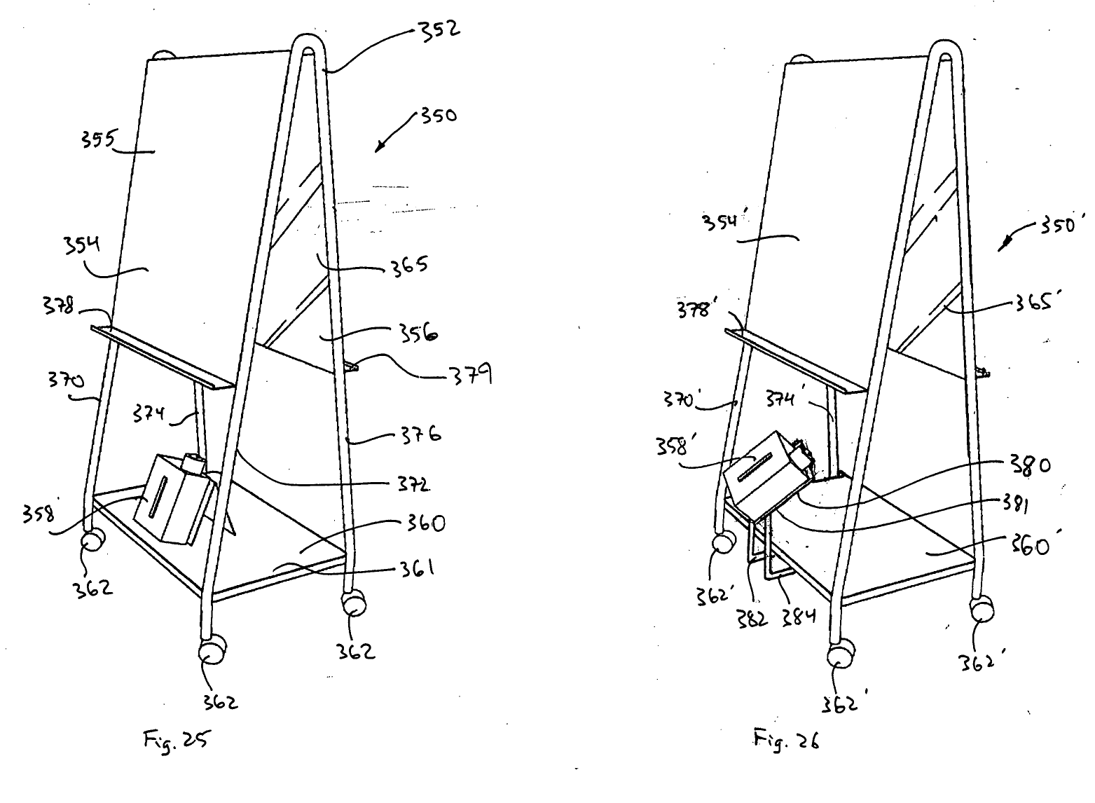

Referring now to FIG. 26, yet one additional open style easel/projecting assembly 350′ is illustrated. The embodiment of FIG. 26 is similar to the embodiment of FIG. 25 and therefore, in the interest of simplifying this explanation, only the distinctions between embodiments 350′ and 350 will be described here. Here, it should suffice to say that components of assembly 350′ that are similar to components of assembly 350 are labeled with the same numbers followed by a prime (i.e., “′”).

The primary difference between assembly 350′ and assembly 350 is that an optional projector unit shelf assembly 381 for supporting projector 358′ at an optimal angle with respect to reflecting surface 365′ is provided as part of assembly 350′. To this end, shelf assembly 381 includes first and second arm members 382 and 384 and an angled support member 380. Arm members 382 and 384 are mounted to an undersurface (not labeled) of horizontal member 360′ and extend laterally therefrom. At distal ends, each of arm members 382 and 384 extend substantially vertically upward below tray 378′. Angled support member 380 is mounted to the distal top ends of arm members 382 and 384 and is angled upwardly and rearwardly toward reflecting surface 365′. Unit 358′ is receivable on a generally top surface of angled member 380 so that unit 358′ projects at an optimal angle toward surface 365′. Although not illustrated, in at least some embodiments, it is contemplated that the angle of member 380 may be alterable such that an optimal projecting angle for all circumstances is definable.

### Ninth Embodiment

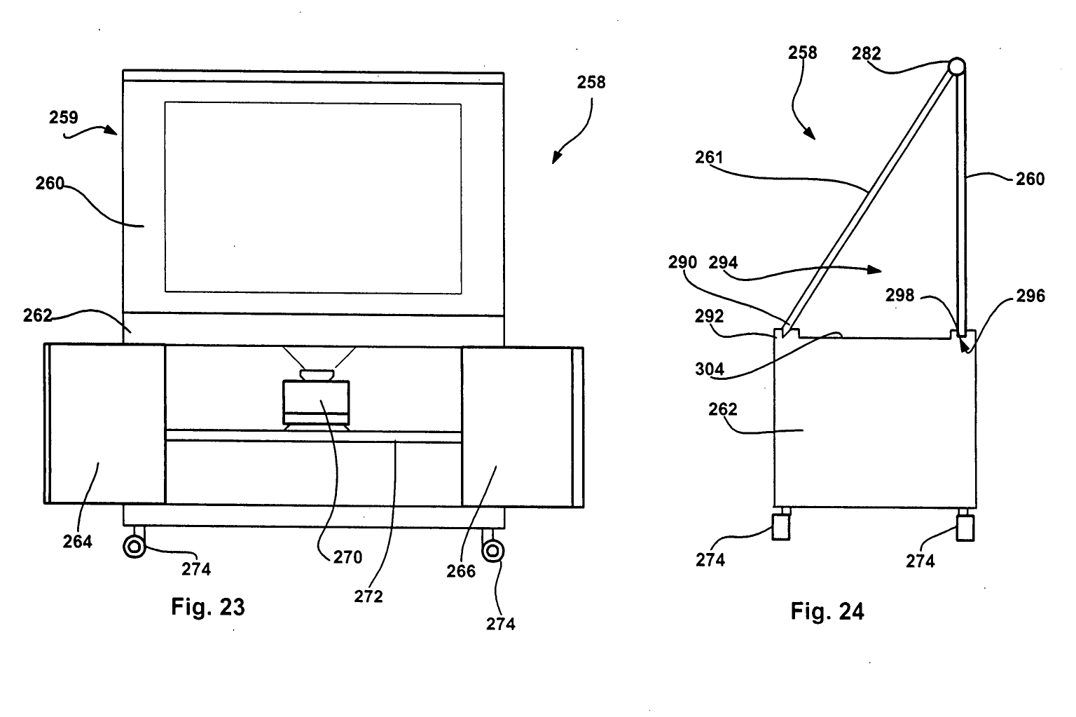

Referring now to FIGS. 23 and 24, a ninth convertible screen assembly 258 is illustrated. As can be seen, assembly 258 includes a supply cart 262 that is mounted on wheels or casters 274 that facilitate movement of the cart 262 within a facility. Cart 262 includes a plurality of rigid walls that form a storage compartment including, in the illustrated embodiment, a single shelf member 272 and doors 264 and 266 that swing open and closed to gain access to the space within the cart structure. In the illustrated example, a projector unit 270 is supported on the top surface of shelf member 272.

Several features of cart 262 facilitate conversion of cart 262 into a projection configuration. To this end, specifically, a top surface of cart 262 forms two grooves 298 and 292 for receiving the lower ends 296 and 290 of a screen member 260 and a reflecting member 261, respectively. Groove 298 that receives the lower end 296 of screen member 260 runs along the front edge of cart 262 above doors 264 and 266. Groove 292 runs along the length of a rear edge of cart 262. As illustrated, in at least one contemplated embodiment, members 260 and 261 are secured at their top ends by a hinge 282 to form a screen/reflecting member assembly 259. As illustrated, a length of reflecting member 261 is greater than the length of screen member 260 such that, when the lower ends 290 and 296 of members 261 and 260, respectively, are received within channels 292 and 298, respectively, member 261 is angled and member 260 is substantially vertically positioned and supported. In at least some embodiments it is contemplated that some type of locking mechanism to rigidly lock the relative juxtaposition of members 260 and 261 will be provided.

In addition to forming channels 292 and 298, the top surface of cart 262 also forms an opening 304 through which projector 270 can project information toward reflecting member 261. In at least some embodiments, although not illustrated, it is contemplated that a top member, similar to shelf member 272, may be provided that is dimensioned to be received within opening 304 to thereby close opening 304 when not being used for projection purposes.

### Tenth Embodiment

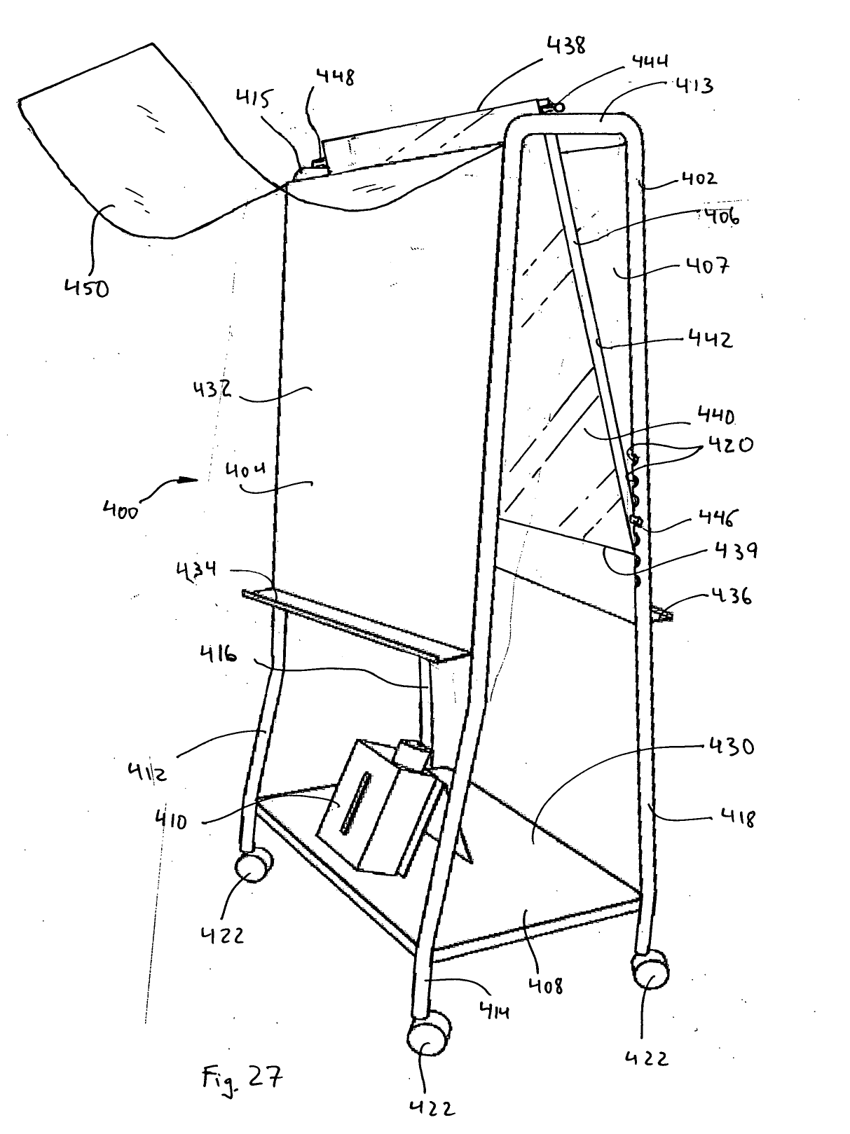

Referring now to FIG. 27, one additional easel/projector assembly 400 is illustrated wherein the easel assembly, like the seventh and eighth embodiments described above, has a relatively open configuration. Assembly 400 includes a support structure 402, a translucent rear projecting screen member 404, a reflecting member 406, a rear member 407, a single horizontal support member 408 and a projector unit 410. Support structure 402 includes four substantially upright support members or bars 412, 414, 416 and 418 as well as two substantially horizontal upper bars or members 413 and 415. The upright support members include a front pair 412 and 414 and a rear pair 416 and 418. Front pair 412 and 414 are spaced apart and are substantially parallel to each other. Similarly, rear pair 416 and 418 are spaced apart and are parallel to each other. Rear pair 416 and 418 angle toward front pair 412 and 414 substantially along the entire length of members 416 and 418 as those members extend upwardly. Members 412 and 414 angle upwardly toward members 416 and 418 for approximately the lower one-third of members 412 and 414 and thereafter, extend substantially vertically upward along the top two-thirds of each of members 412 and 414. Horizontal member 415 is integrally connected to the top ends of each of upper members 412 and 416. Similarly, horizontal member 413 is integrally connected to the top ends of upper members 414 and 418. Each of members 416 and 418 forms a plurality of notches, two of which are identified by numeral 420 along a midsection thereof which open toward facing members 412 and 414, respectively. Separate wheels or casters 422 are provided at the bottom ends of each of members 412, 414, 416 and 418 to facilitate transport of assembly 400 within a facility.

Horizontal member 408 is mounted proximate the lower ends of members 412, 414, 416 and 418 just above casters 422 and forms a substantially horizontal support surface 430. Projector unit 410 is positionable on surface 430 so as to direct images generally upwardly and toward the space between second support pair 416 and 418.

Referring still to FIG. 27, screen member 404 is a rigid screen member and is mounted between the top portions of support members 412 and 414 such that a front viewing surface 432 faces away from support members 416 and 418. Rear member 407 is a rigid substantially flat member which is mounted between the top portions of support members 416 and 418. A tray 434 is provided along the bottom edge of screen member 404 for holding accessories. Similarly, a tray 436 is provided along the bottom edge of an external surface (not labeled) of rear member 407 for holding accessories.

Reflecting member 406 is a rigid rectilinear member having a top edge 438 and a bottom edge 439 and first and second lateral edges 442 (only one illustrated and labeled) that forms a reflecting surface 440. A pair of posts 444 and 446 extend laterally from lateral edge 442. A first post 444 extends laterally from lateral edge 442 proximate top edge 434 while the second post 446 extends laterally from edge 442 proximate lower edge 439. Similarly, a pair of posts (only one illustrated) including a top post 448 and a bottom post (not illustrated) extend from the second lateral edge of member 406, the top post 448 proximate the top edge 438 and the bottom post proximate bottom edge 439. As illustrated, the bottom posts (e.g., 446) are sized and dimensioned so that they are receivable within slots 420 to hold reflecting member 406 there above. Top posts 448 and 444 extend laterally such that combined lengths of posts 444 and 448 and the width of member 406 is greater than the distance separating horizontal members 413 and 415. Thus, as illustrated, reflecting member 406 can be mounted within the space between screen member 404 and rear member 407 by placing posts 448 and 444 on the top edges of members 415 and 413, respectively, and placing the bottom posts (e.g., 446) within slots 420 at similar heights in rear support members 416 and 418. The angle of reflecting member 406 can be changed by simply moving reflecting member 406 upward or downward and placing the bottom posts 446 in a different set of slots 420.

As illustrated, projecting unit is positionable such that images projected thereby reflect off surface 440 and toward the rear surface (not labeled) of screen member 404 such that the images are viewable on front surface 432. As in the above embodiments, here the surface 432 may be a writable/erasable surface such that, in addition to facilitating rear projection viewing, surface 432 also facilitates manual application of information for sharing purposes.

Referring still to FIG. 27, one additional feature of assembly 400 is a clear plastic cover member 450 that may be provided as a temporary cover member for surface 432. Here, for at least some embodiments, surface 432 itself may not be an erasable/writable surface but, instead, may be a tacky type surface or, in some case, may simply be a projection viewing surface that is not erasable/writable. Plastic cover member 450 is secured to the top edge of member 404 and has dimensions similar to the dimensions of surface 432 such that, when cover 450 is placed over surface 432, cover 450 substantially covers the entire surface 432. When it is not necessary to manually apply information on a projected image, member 450 can be flipped up and over the top of members 406 and 407 and, when it is necessary to manually apply information to the projected image, member 450 can be flipped down over surface 432 to protect surface 432. Where surface 432 is tacky, the tacky surface can help to maintain member 450 thereon.

While the invention may be susceptible to various modifications and alternative forms, specific embodiments have been shown by way of example in the drawings and have been described in detail herein. However, it should be understood that the invention is not intended to be limited to the particular forms disclosed. For example, while various coupling assemblies are described above, many other coupling assemblies are contemplated for mounting screen members and reflecting members to supporting structure. For instance, one exemplary mounting structure is described in U.S. patent application Ser. No. 10/094,395 which is entitled “Display Board System” where mounting brackets clip to the top edge of a display board and include horizontal pads suitable to support the board in a hanging position from a horizontal surface. The brackets described in that application may be suitable in some cases to support a screen member in a position hanging from a shelf member or the like. Other coupling structure is contemplated.

As another example, in at least some cases where supporting structure is provided for the screen and reflecting member within a closet, in a cabinet or over a work surface, storage cart, etc., embodiments of the present invention may be employed.

Thus, the invention is to cover all modifications, equivalents, and alternatives falling within the spirit and scope of the invention as defined by the following appended claims.

To apprise the public of the scope of this invention, the following claims are made:

1. A convertible projection assembly comprising:
at least a first support member including at least a first portion adjacent a projecting space that is bound on a first side by a screen receiving space;
at least a first accessory member removably supportable by the first portion so as to reside substantially within at least one of the projecting space and the screen receiving space, the first accessory member removable from the at least one of the projecting space and the screen receiving space to provide a substantially unobstructed space;
a screen member including oppositely facing front and rear surfaces, the screen member releasably supportable by the support member within the screen receiving space; and
a projector unit supportable by the support member to project an image, when the first accessory member is removed from the at least one of the projecting space and the screen receiving space, the projected image passing through the projecting space and subtending the rear surface of the screen member.

2. The assembly of claim 1 further including a reflecting member including a reflecting surface, the reflecting member supportable by at least one of the support member and the screen member with the reflecting surface forming an angle with the rear surface and an angle with a trajectory of the projected image, the projected image reflecting off the reflecting surface and toward the rear surface of the screen member.

3. The assembly of claim 2 wherein the first accessory member is a first shelf member having a first support surface, when the shelf member is supported by the first portion of the support member, the first shelf member substantially within the projecting space and the support surface facing substantially upward.

4. The assembly of claim 3 wherein the assembly includes an upper sub-set of shelf members, the first shelf member being one of the upper sub-set of members, the upper sub-set of members simultaneously supportable by the first portion of the support member at spaced apart locations along the first portion of the support member within the projecting space, each of the upper sub-set members removable from the projecting space to provide a substantially unobstructed projecting space.

5. The assembly of claim 4 wherein the support member includes a lower portion below the first portion and adjacent a lower space, the assembly further including a lower sub-set of shelf members supportable at spaced apart locations along the lower portion within the lower space.

6. The assembly of claim 5 wherein each of the shelf members is releasably supportable by the support member.

7. The assembly of claim 3 wherein the support member includes a lower portion below the first portion and adjacent a lower space, the assembly further including at least a second shelf member having a support surface, the second shelf member supportable by the lower portion within the lower space with the second shelf member support surface facing substantially upward, the projector unit positionable on the support surface of the second shelf member.

8. The assembly of claim 3 further including at least a second support member having a first portion that is adjacent the projecting space, the first and second support members forming a first pair of spaced apart support members where the projecting space is at least partially to a first side of the first portions of the first pair of members, the first shelf member supportable by both of the first portions of the first pair members and the screen member supportable by both of the first portions of the first pair members.

9. The assembly of claim 8 wherein the screen receiving space is between the first portions of the first pair members and the projection space is substantially to a first side of the first member pair.

10. The assembly of claim 9 further including at least first and second coupler members supportable by the first and second support members at different locations along the lengths of the first portions, the first shelf member supportable by the first and second coupler members substantially within the projecting space and the screen member supportable by the first and second coupler members within the screen receiving space.

11. The assembly of claim 10 wherein each of the first portions of the first pair members forms a plurality of pin holes spaced along its length, each coupler member including a pin receivable within the holes, the screen member including first and second slot members that open downwardly to receive and be supported by the first and second pins, respectively, when the pins are received within the holes.

12. The assembly of claim 11 further including at least third and fourth pins receivable within the pin holes, the screen member including third and fourth slot members that open downwardly to receive and be supported by the third and fourth pins, respectively, when the pins are received within the holes.

13. The assembly of claim 9 wherein, when the shelf member is supported by the support members, the shelf member at least partially resides within the projection space and at least partially resides within the screen receiving space.

14. The assembly of claim 8 wherein the projecting space is substantially to a first side of the first member pair and the screen receiving space is to a second side of the first member pair opposite the first side.

15. The assembly of claim 8 further including at least a second pair of support members, each of the second member pair having a first portion that is adjacent the projecting space, the second member pair spaced apart from each other and spaced apart from the first member pair where the projecting space is substantially between the first and second member pairs, the first shelf member supportable by the first portions of each of the support members in the first and second member pairs.

16. The assembly of claim 15 wherein the screen member includes a screen edge and the reflecting member is secured to the screen edge.

17. The assembly of claim 16 wherein the reflecting member is hingedly connected to the screen edge.

18. The assembly of claim 16 wherein the screen edge is a top edge when the screen member is supported by the first portion of the support member.

19. The assembly of claim 17 further including at least a second pair of support members, each of the second member pair having a first portion that is adjacent the projecting space, the second pair members spaced apart form each other and the second member pair spaced apart from the first member pair where the projecting space is substantially between the first and second member pairs, the reflecting member positionable to extend generally downward from the screen edge and toward the second pair of support members and also supportable by at least one of the second pair members.

20. The assembly of claim 19 wherein each of the second pair members forms at least one pin hole, the assembly further including first and second rear pins receivable within the pin holes and extending therefrom toward each other, a portion of the reflecting member supportable by the rear pins.

21. The assembly of claim 20 wherein each of the first portions of the first pair members and the second pair members forms a plurality of pin holes spaced along its length, the assembly further including at least first and second front pins receivable within the holes formed by the first pair members, the first shelf member supportable by the front and rear pins substantially within the projecting space, the screen member including first and second slot members that open downwardly to receive and be supported by the first and second front pins, respectively, within the screen receiving space.

22. The assembly of claim 21 further including at least third and fourth front pins receivable within the pin holes, the screen member including third and fourth slot members that open downwardly to receive and be supported by the third and fourth pins, respectively.

23. The assembly of claim 2 wherein the screen member includes a screen edge and the reflecting member is secured to the screen edge.

24. The assembly of claim 23 wherein the reflecting member is hingedly connected to the screen edge and the screen edge is a top edge when the screen member is supported by the first portion of the support member.

25. The assembly of claim 24 wherein the reflecting member is rotatable about the hinged edge between at least first and second positions, when in the first position, the reflecting member substantially parallel to the screen member, when in the second position, the reflecting member forming an angle with the screen member.

26. The assembly of claim 24 further including at least a second pair of support members, each of the second member pair having a first portion that is adjacent the projecting space, the second pair members spaced apart form each other and the second member pair spaced apart from the first member pair where the projecting space is substantially between the first and second member pairs, the reflecting member positionable to extend generally downward from the screen edge and toward the second pair of support members and also supportable by at least one of the second pair members.

27. The assembly of claim 1 wherein the screen member is translucent.

28. The assembly of claim 27 wherein the front surface of the screen member is an erasable marker surface.

29. The assembly of claim 1 further including a substantially horizontal guide member rigidly secured to the support member along one of the top and bottom edges of the screen receiving space, the screen member mountable to the guide member for movement between a first position where the screen member is within the screen receiving space and a second position where the screen member is in a storage space adjacent the screen receiving space.

30. The assembly of claim 29 wherein the guide member includes a track member that extends to at least one side of the screen receiving space along an edge of the storage space and the screen member includes a coupler received for sliding motion by the track member.

31. The assembly of claim 30 wherein the track member is positioned along a top edge of the screen receiving space and the top edge of the storage space.

32. The assembly of claim 31 further including at least second and third support members, the second support member spaced apart from the first support member and on opposite sides of the screen receiving space, the third support member spaced apart from the second support member and on a side of the storage space opposite the second support member, the track member also rigidly secured to each of the first and second support members.

33. The assembly of claim 32 wherein the second and third support members form part of a book shelf assembly.

34. The assembly of claim 2 wherein the first accessory member is an easel board having a first surface, when the easel board is supported by the first portion of the support member, the easel board within the screen receiving space and the first surface substantially vertically oriented.

35. The assembly of claim 34 wherein the easel board includes an erasable whiteboard surface.

36. The assembly of claim 34 wherein the projecting space is substantially on a first side of the first support member and the screen receiving space is substantially on a second side of the first support member opposite the first side.

37. The assembly of claim 34 further including a coupler assembly for separately coupling each of the screen member and the easel board to the support structure.

38. The assembly of claim 34 wherein the support member includes wheels at a lower end.

39. The assembly of claim 34 wherein the screen member is translucent and includes an erasable markable front surface.

40. The assembly of claim 34 wherein the first support member is a rectilinear member having an upper edge and wherein the reflecting member converges toward the upper edge.

41. The assembly of claim 40 wherein the first support member forms an opening that defines the screen receiving space.

42. A shelving and display assembly for use with a projector unit that projects a projection image along a trajectory, the assembly comprising:
a shelving assembly including at least first and second support members and a plurality of shelf members supportable substantially within a projecting space by the support members, at least a first sub-set of the shelf members removable from the projecting space to form an essentially unobstructed projecting space bound on one side by a screen receiving space;
a projection screen member including oppositely facing front and rear surfaces, the screen member releasably mountable to the first and second support members within the screen receiving space;
a reflecting member including a reflecting surface, when the sub-set of shelf members is removed from the projecting space, the reflecting member supportable by at least one of the screen member and the support members at least partially within the projecting space with the reflecting surface forming an angle with the rear surface; and
a projector support member linked to at least one of the support members and forming at least one surface for supporting the projector unit outside the projecting space;
wherein, when the first sub-set of the shelves is removed from the projecting space, the screen member is supported in the screen receiving space, the reflecting member is supported by one of the support members and the screen member and the projecting unit is received on the projector support member, an image projected by the projector unit is reflected off the reflecting surface and passes through the projecting space toward the rear surface of the screen member.

43. The assembly of claim 42 wherein each of the first and second support members forms a plurality of pin holes along its length and the screen member includes at least first and second slot members that form slots that face downwardly when the screen member is mounted to the support members, the assembly further including at least first and second pins, first ends of each pin receivable within the holes and second ends of each pin receivable within the slots to mount the screen member to the support members.

44. The assembly of claim 42 wherein the screen member includes third and fourth slot members that form slots that face downwardly when the screen member is mounted to the support members, the assembly further including at least third and fourth pins having first ends receivable within the holes and second ends receivable within the slots of the third and fourth slot members to mount the screen member to the support members.

45. The assembly of claim 42 wherein the pin hole that receives the first pin is one of a first sub-set of pin holes that forms a first front hole line, the pin hole that receives the second pin is one of a second sub-set of pin holes that forms a second front hole line, one of the support members forming at least a first rear pin hole that is spaced apart from the first front hole line, the assembly further including a first rear pin having a first end receivable within the rear pin hole and a second end that extends from the rear pin hole and supports a lower end of the reflecting member when the reflecting member is supported by the one of the support members and the screen member.

46. The assembly of claim 45 wherein one of the support members forms at least a second rear pin hole that is spaced apart from the second front hole line and opposite the first rear pin hole, the assembly further including a second rear pin having a first end receivable within the second rear pin hole and a second end that extends from the second rear pin hole and that also supports a lower end of the reflecting member when the reflecting member is supported by the one of the support members and the screen member.

47. The assembly of claim 46 wherein the support member that forms the first rear pin hole forms a first rear hole line including a plurality of holes spaced along the support member and the support member that forms the second rear pin hole forms a second rear hole line including a plurality of holes spaced along the support member, the assembly including sets of four pins for each of the shelf members in the first subset where each set of four pins is receivable within a set of four pin holes to support an associated shelf within the projecting space.

48. A projector screen assembly for use with a projector unit and a support structure, the projector unit supportable by the support structure for projecting a projection image along a projection path, the assembly comprising:
a screen assembly including:
a projection screen member including oppositely facing front and rear surfaces and a screen edge; and
a reflecting member including a reflecting surface, the reflecting member mounted to the screen member along the screen edge with the reflecting surface facing at least partially in the direction of the rear surface;
wherein, the screen assembly is releasably mountable to the support structure such that the front surface is at least partially vertically oriented, the reflecting surface is at least partially within the projection path and reflects the projected image along a reflected path and the rear surface forms an angle with the reflecting surface such that the reflected image is directed at the rear surface.

49. The assembly of claim 48 wherein the reflecting member is hingedly secured to the screen edge so that the angle between the reflecting member and the screen member is alterable.

50. The assembly of claim 49 wherein the screen member is a translucent screen member and wherein the front surface is an erasable marker surface

51. An easel-screen assembly comprising:
an easel support structure at least in part defining a projecting space bound on one side by a screen receiving space;
a reflecting member mounted to the easel support structure along one boundary of the projecting space, the reflecting member including an at least partially reflecting internal surface facing the projecting space and an oppositely facing external side, the external side for presenting information; and
a translucent screen member including a front viewing surface and an oppositely facing rear surface, the screen member receivable within the screen receiving space such that the rear surface forms an angle with the reflecting surface.

52. The assembly of claim 51 wherein the external side includes an external surface that is a writable/erasable whiteboard surface.

53. The assembly of claim 51 further including an accessory tray mounted to the external side of the reflecting member.

54. The assembly of claim 53 wherein the external side has a lower edge and wherein the tray is mounted along the lower edge of the external side.

55. The assembly of claim 51 further including an accessory tray mounted to the front surface of the screen member.

56. The assembly of claim 55 wherein the front surface has a lower edge and wherein the tray is mounted along the lower edge of the front surface.

57. The assembly of claim 56 further including an accessory tray mounted to the external side of the reflecting member.

58. The assembly of claim 52 further including an accessory tray mounted along a lower edge of the external surface.

59. The assembly of claim 51 for use on a substantially flat ambient surface and, wherein, each of the front surface and the external side form a similar angle with the ambient surface when the screen member is received within the screen receiving space.

60. The assembly of claim 59 wherein each of the front surface and the external side forms an angle between 60 and 75 degrees with respect to the ambient surface when the screen member is received within the screen receiving space.

61. The assembly of claim 51 wherein each of the reflecting member and the screen member include an upper edge and wherein the upper edges of the reflecting member and the screen member are secured together.

62. The assembly of claim 51 wherein the support structure includes a substantially planar front member including front and rear surfaces, the front member forming the screen receiving space, the screen member receivable within the screen receiving space with the rear surface of the screen member facing in the same direction as the rear surface of the front member.

63. The assembly of claim 51 further including a supporting member linked to the support structure for supporting a projector.

64. The assembly of claim 63 further including a projector positionable on the supporting member to project images along a trajectory that reflects off the reflecting surface and onto the rear surface of the screen member.

65. The assembly of claim 64 wherein the projector is positionable on the supporting member substantially below the screen receiving space.

66. The assembly of claim 64 wherein the projector is removable from the supporting member.

67. The assembly of claim 64 wherein the support structure is open to at least one side to facilitate access to the supporting member.

68. The assembly of claim 51 wherein the screen member is secured within the screen receiving space.

69. The assembly of claim 68 further including a whiteboard member supportable adjacent the front surface at least in part by at least one of the front surface and the support structure.

70. The assembly of claim 69 further including a tray that extends along the length of a lower edge of the screen member, the whiteboard member supportable on a top surface of the tray.

71. The assembly of claim 69 further including a retaining means linked to at least one of the front surface and the support structure for retaining the whiteboard adjacent the front surface.

72. The assembly of claim 51 wherein the screen member is removable from the screen receiving space, the assembly further including a whiteboard member positionable within the screen receiving space when the screen member is removed from the screen receiving space.

73. The assembly of claim 72 where the facing internal surface and the rear surface of the front member form a storage space for receiving at least the screen member when the screen member is removed from the screen receiving space.

74. The assembly of claim 51 wherein the front surface of the screen member forms a markable/erasable whiteboard surface.

75. The assembly of claim 51 further including wheels mounted to the bottom of the support structure to facilitate movement of the assembly.

76. The assembly of claim 51 wherein the support structure is substantially open below the screen member and the reflecting member.

77. The assembly of claim 76 further including a supporting member linked to the support structure for supporting a projector below the screen member.

78. The assembly of claim 77 further including a projector positionable on the supporting member to project images along a trajectory that reflects off the reflecting surface and onto the rear surface of the screen member.

79. An easel-screen assembly comprising:
an easel support structure;
a translucent screen member including a viewing front surface and an oppositely facing rear surface;
a reflecting member forming an internal surface and an oppositely facing external surface, the internal surface of the reflecting member at least in part forming a reflecting surface;
wherein, the screen member and the reflecting member are mounted to the support structure on opposite sides of a projecting space with the rear surface facing the reflecting surface.

80. The assembly of claim 79 for use on a substantially flat ambient surface wherein the front surface forms an acute angle with the ambient surface.

81. The assembly of claim 80 wherein the external surface of the reflecting member also forms an acute angle with the ambient surface and wherein the angles formed by the external surface and the front surface with the ambient surface are substantially identical.

82. The assembly of claim 81 wherein the angles formed by the external surface and the front surface with the ambient surface are each between 60 and 75 degrees.

83. The assembly of claim 79 wherein the support structure includes a projector supporting member and the support structure supports the screen member above the supporting structure thereby facilitating substantially unimpeded access to the supporting structure.

84. The assembly of claim 83 wherein the screen member includes a lower edge and wherein the assembly further includes a tray mounted along the lower edge of the screen member.

85. The assembly of claim 79 wherein the support structure is open to lateral sides thereby allowing substantially unimpeded access to a space between the screen member and the reflecting member.

86. The assembly of claim 79 wherein the front surface is substantially vertical.

87. The assembly of claim 79 for use on a substantially flat ambient surface wherein the angle of the reflecting member with respect to the ambient surface is alterable.

88. The assembly of claim 79 further including an rear member mounted to the support structure, the reflecting member juxtaposed between the screen member and the rear member.

89. The assembly of claim 88 for use on a substantially flat ambient surface wherein an external surface of the rear member forms an acute angle with the ambient surface.

90. The assembly of claim 79 wherein the reflecting member angle with the screen member is adjustable.

91. A presentation assembly comprising:
a support structure;
a translucent screen member including a viewing front surface and an oppositely facing rear surface, the screen member mountable to the support structure; and
a reflecting member forming an internal surface and an oppositely facing external surface, the internal surface of the reflecting member at least in part forming a reflecting surface, the reflecting member one of mountable to the support structure and mountable to the screen member such that the reflecting surface at least in part faces the rear surface of the screen member;
wherein, when the screen member is mounted to the support structure and the reflecting member is one of mounted to the support structure and mounted to the screen member, the reflecting member and the screen member form a projecting space therebetween and the sides of the support structure are substantially open thereby facilitating access to the projecting space.

92. The assembly of claim 91 wherein screen member is releasably mountable to the support structure.

93. The assembly of claim 91 wherein the reflecting member is one of releasably mountable to the screen member and releasably mountable to the support structure.

94. The assembly of claim 92 wherein the screen member and reflecting member are mounted to the support structure.

95. The assembly of claim 91 wherein the support structure includes a cart having a top surface and wherein the screen member and reflecting member are releasably mountable to the top surface.

96. The assembly of claim 95 further including wheels mounted to the underside of the cart.

97. The assembly of claim 91 wherein the support structure includes at least one substantially vertical support member of a shelf assembly.

98. The assembly of claim 91 for use on a substantially flat ambient surface wherein the support structure includes an easel support structure and wherein each of the screen member and the reflecting member form an acute angle with the ambient surface.

99. A method for use with a shelf assembly including an upright support structure and a plurality of removable shelves that are supportable by the support structure in substantially horizontal juxtapositions within a projecting space, the method for converting a shelf assembly to a rear projection assembly and comprising the steps of:
removing the shelves from within the projecting space;
supporting a screen member on the upright support structure with a front screen member surface substantially vertically upright; and
supporting a reflecting member having a reflecting surface via at least one of the support structure and the screen member with the reflecting surface forming an angle with the screen member surface; and
positioning a projector unit with respect to the reflecting surface so that the a projected image from the projector is directed along a trajectory that reflects off the reflecting surface and toward the rear surface of the screen member.
